(19) United States
(12) Patent Application Publication
(10) Pub. No.: US 2013/0340500 A1
(43) Pub. Date: Dec. 26, 2013

(54) SENSOR SYSTEMS AND MONITORING SYSTEMS

(71) Applicants: CRAIG MILLER, PITTSBURGH, PA (US); MICHAEL STURDEVANT, CONCORD TOWNSHIP, OH (US); WILLIAM KAIGLER, WEXFORD, PA (US)

(72) Inventors: CRAIG MILLER, PITTSBURGH, PA (US); MICHAEL STURDEVANT, CONCORD TOWNSHIP, OH (US); WILLIAM KAIGLER, WEXFORD, PA (US)

(21) Appl. No.: 13/829,583

(22) Filed: Mar. 14, 2013

Related U.S. Application Data
(60) Provisional application No. 61/662,906, filed on Jun. 21, 2012.

(51) Int. Cl. G01N 25/56

(52) U.S. Cl. CPC G01N 25/56
USPC 73/29.02; 374/100; 374/121

(57) ABSTRACT

A method of monitoring a space to determine at least one change in state related to at least one activity includes analyzing an amount of water vapor in the air over time and relating a change in the amount of water vapor in the air over time to the at least one change in state. In a number of embodiments, the at least one change in state is related to a kitchen activity which causes a change in the amount of water vapor in the air. Changes in dew point over time may, for example, are determined. In a number of embodiments, changes in dew point over time are determined by measuring temperature and relative humidity over time and determining dew point from measured temperature and measured relative humidity. Changes in dew point over time may, for example, used to identify or distinguish the activity from a plurality of possible activities associated with the change in state. At least one of change in dew point, change in relative humidity and change in temperature over time may be used (either alone or in any combination thereof) to identify the activity associated with the change in state.

### CROSS-REFERENCE TO RELATED APPLICATIONS

This application claims benefit of U.S. Provisional Patent Application Ser. No. 61/662,906, filed Jun. 21, 2012, the disclosure of which is incorporated herein by reference.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

A number of systems are available to monitor the wellbeing of a person. For example, currently available personal emergency response systems (PERS) provide a wearable communicator actuatable by the user in the case of an emergency. Various clinical monitoring systems can, for example, be used to monitor physiological parameters, such as blood pressure, blood glucose levels, weight, etc. A number of home or office remote monitoring systems are based upon security technology. Current remote monitoring systems and/or methods for monitoring the wellbeing of a person are expensive, difficult to implement, and usually are reactive to changes in the person's condition. As a result, remote caregivers are typically alerted of a problem with the person only in the event of an acute attack or when the person initiates an alert, typically by pressing a button. Moreover, a number of sensors available for use in such monitoring system are not well-suited for the purpose.

### SUMMARY

In one aspect, a method of monitoring a space to determine at least one change in state related to at least one activity includes analyzing an amount of water vapor in the air over time and relating a change in the amount of water vapor in the air over time to the at least one change in state. In a number of embodiments, the at least one change in state is related to a kitchen activity which causes a change in the amount of water vapor in the air. Changes in dew point over time may, for example, be determined. In a number of embodiments, changes in dew point over time are determined by measuring temperature and relative humidity over time and determining dew point from measured temperature and measured relative humidity. Changes in dew point over time may, for example, used to identify or distinguish the activity from a plurality of possible activities associated with the change in state. In a number of embodiments, at least one of change in dew point, change in relative humidity and change in temperature over time is used (either alone or in any combination thereof) to identify the activity associated with the change in state.

The method may, for example, further include associating the at least one change in state with wellness of a person. The method may, for example, further include associating the at least one change in state with unauthorized presence within a space and/or with a security breach.

In a number of embodiments, a beginning (for example, time of beginning) of the at least one change in state is determined and an end (for example, time of end and/or duration) in the at least one change in state is determined. A change in state may, for example, be an on/off state change of a monitored system or a component of such a monitored system.

In another aspect, a system to sense at least one change in state related to at least one activity includes at least one sensor system to sense an amount of water vapor in the air, a processor system in communicative connection with the sensor system, and a communication system in communicative connection with the processor system. The sensor system may, for example, be adapted to measure changes in dew point. The sensor system may, for example, include at least a first sensor adapted to sense temperature over time and at least a second sensor adapted to sense relative humidity over time. Dew point over time may, for example, be calculated from temperature and relative humidity. The system further includes a power supply, a processor system in communicative connection with the first sensor and the second sensor, and a communication system in communicative connection with the processor system.

In a number of embodiments, the at least one change in state is related to a kitchen activity which causes a change in at least one of temperature, relative humidity or the amount of water vapor in the air. Changes in dew point over time may, for example, be used to identify the activity associated with a change in state. In a number of embodiments, at least one of change in dew point, change in relative humidity and change in temperature over time (either alone or in any combination thereof) is used to identify the activity associated with the change in state.

The at least one change in state may, for example, be associated with wellness of a person. The at least one change in state may, for example, be associated with unauthorized presence within a space and/or with a security breach.

In another aspect, a system for monitoring wellness of a person includes a local system in the vicinity of the person including a plurality of sensor systems. Each of the plurality of sensor systems is adapted to monitor changes in state (for example, in one or more monitored system) caused by activity or lack of activity of the person. At least one of the plurality of sensor systems is a sensor system to sense an amount of water vapor in the air. The sensors system to sense an amount of water vapor in the air includes a processor system in communicative connection therewith, and a communication system in communicative connection with the processor system. The system further includes a local data communication device in communicative connection with each of the plurality of sensor system to receive data from each of the plurality of sensor systems. The system may further include a remote system in communication with the local data communication device. The remote system may, for example, include a processing system to process data from the plurality of sensor systems based upon predetermined rules. In a number of embodiments, the local data communication device is programmed to transmit data to the remote system in batches separated by intervals of time. The data transmitted to the remote system includes information on state history of the monitored systems since a previous data transmission to the remote system.

In a further aspect, a system to sense at least one change in state related to at least one activity includes at least a first sensor adapted to sense temperature over time, at least a second sensor adapted to sense a variable related to humidity over time, a power supply, a processor system in communicative connection with the first sensor and the second sensor, and a communication system in communicative connection with the processor system. The system is adapted to determine the at least one change in state on the basis of at least one of change in temperature and change in variable related to humidity over time. The variable related to humidity may, for example, be relative humidity. The system may, for example, be further adapted to determine a variable dependent upon temperature and relative humidity. In a number of embodiments, the variable dependent upon temperature and relative humidity is dew point. At least one of change in dew point, change in relative humidity and change in temperature over time may, for example, be used (individually or in any combination thereof) to determine the at least one change in state.

In another aspect, a method of monitoring a space to determine at least one change in state related to at least one activity includes measuring temperature over time, measuring a variable related to humidity over time, and determining the at least one change in state on the basis of at least one of change in temperature and change in the variable related to humidity over time. The variable related to humidity may, for example, be relative humidity. The system may, for example, be further adapted to determine a variable dependent upon temperature and relative humidity. In a number of embodiments, the variable dependent upon temperature and relative humidity is dew point. At least one of change in dew point, change in relative humidity and change in temperature over time (individually or in any combination thereof) may, for example, be used to determine the at least one change in state.

In a further aspect, a system for monitoring wellness of a person includes a local system in the vicinity of the person including a plurality of sensor systems. Each of the plurality of sensor systems is adapted to monitor changes in state caused by activity or lack of activity of the person. At least one of the plurality of sensor systems is an activity sensor system including a sensor to sense temperature and a sensor to sense a variable related to humidity. The activity sensor system includes a processor system in communicative connection with the sensor to sense temperature and the sensor to sense a variable related to humidity, and a communication system in communicative connection with the processor system. The system further includes a local data communication device in communicative connection with each of the plurality of sensor systems to receive data from each of the plurality of sensor systems. The variable related to humidity may, for example, be relative humidity, and the activity sensor system may, for example, be further adapted to determine a variable dependent upon temperature and relative humidity. In a number of embodiments, the variable dependent upon temperature and relative humidity is dew point. At least one of change in dew point, change in relative humidity and change in temperature over time may, for example, be used to determine the at least one change in state.

In another aspect, a method of monitoring a system to determine at least one change in state of the system includes analyzing temperature over at least one area of the system over time and relating a change in the temperature over the at least one area of the system over time to the at least one change in state. Temperature of the at least one area may, for example, be integrated. Integrating may, for example, include averaging (over the area). The integrated temperature may, for example, be determined by at least one temperature sensor having a field of view corresponding to at least a portion of the at least one area. The temperature sensor may, for example, be an IR sensor spaced from the system. The at least one change in state may, for example, be related to a kitchen activity effected using the system.

In a number of embodiments, at least a rate of change of the integrated temperature and an ultimate temperature change are used in determining the at least one change in state. Temperature over a plurality of areas of the system may be analyzed over time and related to the at least one change in state.

The method may, for example, further include associating the at least one change in state with wellness of a person. The method may, for example, further include associating the at least one change in state with unauthorized presence within a space and/or with a security breach.

In a number of embodiments, a beginning of the at least one change in state is determined and an end in the at least one change in state is determined.

In a further aspect, a system to sense at least one change in state related to an activity includes at least one sensor system to measure temperature over at least one area of a monitored system, a processor system in communicative connection with the sensor system, and a communication system in communicative connection with the processor system. Temperature of the at least one area may, for example, be integrated. Integrating may, for example, include averaging. The integrated temperature may, for example, be determined by at least one temperature sensor having a field of view corresponding to at least a portion the at least one area.

In still a further aspect, a system for monitoring wellness of a person includes a local system in the vicinity of the person including a plurality of sensor systems. Each of the plurality of sensor systems is adapted to monitor changes in state (for example, in at least one monitored system) caused by activity or lack of activity of the person. At least one of the plurality of sensor systems is a sensor system to measure temperature over at least one area of a monitored system. The sensor system further includes a processor system in communicative connection with the sensor system to measure temperature, and a communication system in communicative connection with the processor system. The system further includes a local data communication device in communicative connection with each of the plurality of sensor systems to receive data from each of the plurality of sensor systems. The temperature of the at least one area may, for example, be integrated. Integrating of the temperature may, for example, include averaging. The integrated temperature may, for example, be determined by at least one temperature sensor having a field of view corresponding to at least a portion of the at least one area.

The system may, for example, further include a remote system in communication with the local data communication device. The remote system includes a processing system to process data from the plurality of sensor systems based upon predetermined rules. The local data communication device may, for example, be programmed to transmit data to the remote system in batches separated by intervals of time. The data transmitted to the remote system may, for example, include information on state history of the monitored systems since a previous data transmission to the remote system.

Any of the system hereof may further include a sensor adapted to detect smoke. Likewise, any of the methods hereof may further include providing a sensor to detect smoke or include detecting smoke.

The present devices, system and/or methods, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates a schematic representation an embodiment of a system for collecting data from a plurality of devices for remote wellness monitoring.

FIG. 1B illustrates another schematic representation of the system of FIG. 1A.

FIG. 1C illustrates a another schematic representation of the system of FIG. 1A.

FIG. 2A illustrates a side view an embodiment of an energy sensor system or energy sensor for connection to an electrical outlet and to an electrically powered device or system to be monitored, wherein the energy sensor system is removed from connection with the electrical outlet.

FIG. 2B illustrates the energy sensor system of FIG. 2A in connection with the electrical outlet and a plug of a device to be monitored in alignment for electrical connection to an outlet of the energy sensor system.

FIG. 2C illustrates a schematic diagram of the components of the energy sensor system of FIG. 2A.

FIG. 2D illustrates a circuit diagram of the energy sensor system of FIG. 2A.

FIG. 2E illustrates a flowchart for the operation of an embodiment of an energy sensor system such as the energy sensor system of FIG. 2A.

FIG. 3A illustrates a schematic illustration of an embodiment of a sensor system to determine temperature changes over a defined field of view

FIG. 3B illustrates an embodiment of a circuit diagram of the sensor system of FIG. 3A.

FIG. 3C illustrates a flow chart setting forth an embodiment of a methodology of operation of the sensor system of FIG. 3A.

FIG. 3D(i) illustrates a representative embodiment of a sensor system configuration used in a number of studies of a sensor system of FIG. 3A.

FIG. 3D(ii) illustrates the results of studies wherein the oven is turned on to approximately 350° and left on for approximately 22 minutes, while the range burners are left off.

FIG. 3D(iii) illustrates the results of a continuation of the studies of FIG. 3D(ii), wherein the oven is turned off and the stove top temperature is monitored over time.

FIG. 3D(iv) illustrates the results of a continuation of the studies of FIG. 3D(iii).

FIG. 3D(v) illustrates the result of studies wherein the left rear burner is turned on to its lowest setting and to its highest setting, while the oven is off.

FIG. 3D(vi) illustrates the result of studies wherein the right burner is turned on to its lowest setting, while the oven is off.

FIG. 3E illustrates a schematic illustration of an embodiment of a sensor system to determine changes in temperature, relative humidity and dew point over time and relate such changes to changes in states of certain devices, event and/or activities (for example, kitchen devices, events and/or activities).

FIG. 3F illustrates an embodiment of a circuit diagram of the sensor system of FIG. 3E.

FIG. 3G illustrates a flow chart setting forth an embodiment of a methodology of operation of the sensor system of FIG. 3E.

FIG. 3H illustrates representative data from an embodiment of a sensor system of FIG. 3E.

FIG. 4A illustrates an embodiment of a screen for login and for device rule settings.

FIG. 4B illustrates an embodiment of a screen summarizing set rules for alerts and an embodiment of a screen summarizing resident information.

FIG. 4C illustrates an embodiment of a screen summarizing caregiver information.

FIG. 4D illustrates an embodiment of a screen setting forth an activity summary derived from state-based sensor data.

FIG. 4E illustrates an embodiment of a screen setting forth entertainment activity derived from state-based sensor data.

FIG. 4F illustrates an embodiment of a screen setting forth activity derived from state-based kitchen device sensor data.

FIG. 4G illustrates an embodiment of a screen setting forth sleep activity derived from state-based sensor data.

FIG. 4H illustrates an embodiment of a screen setting forth water use derived from state-based sensor data.

FIG. 5 illustrates a flowchart for an embodiment of methodology for the uploading of data to the remote system, the determination of associated or relevant rules, and the application of such rule to determine whether an alert should be generated.

FIG. 6 illustrates a flowchart for an embodiment of methodology for alerting one or more caregivers via one or more communication devices or systems and including an optional attempt to confirm a monitored person is OK via an attempt to communicate with or contact the monitored person.

### DETAILED DESCRIPTION

As used herein and in the appended claims, the singular forms “a,” “an”, and “the” include plural references unless the content clearly dictates otherwise. Thus, for example, reference to “a sensor” includes a plurality of such sensors and equivalents thereof known to those skilled in the art, and so forth, and reference to “the sensor” is a reference to one or more such sensors and equivalents thereof known to those skilled in the art, and so forth.

In a number or representative embodiments, a remote wellness monitoring system monitors basic day-to-day activities or lack of activity of person 5, such as sleeping behavior, television usage, eating habits, water consumption, etc. The system provides real time monitoring of parameters indicative of the overall wellbeing of the resident and provides timely alerts designed, for example, to help prevent an acute episode. The system may, for example, be used in conjunction with a personal emergency response system (PERS) or as a standalone system, to provide relatively comprehensive remote monitoring for a remote caregiver at a price and ease of installation that is currently not available.

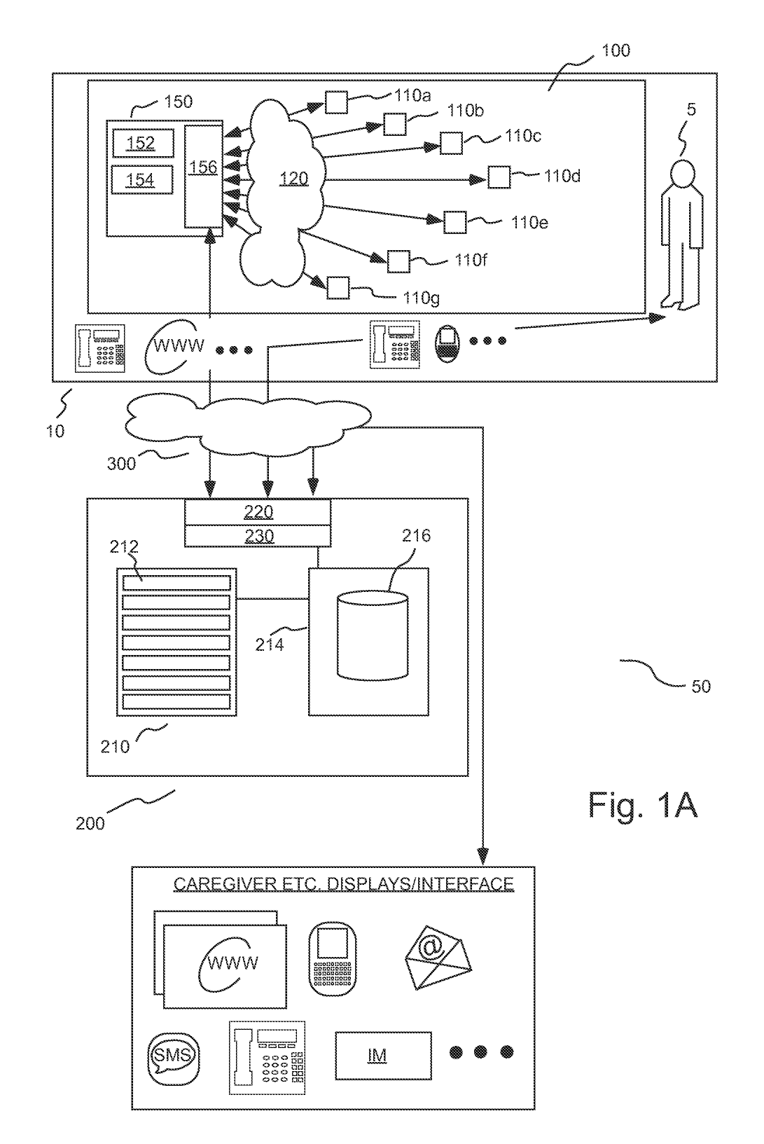

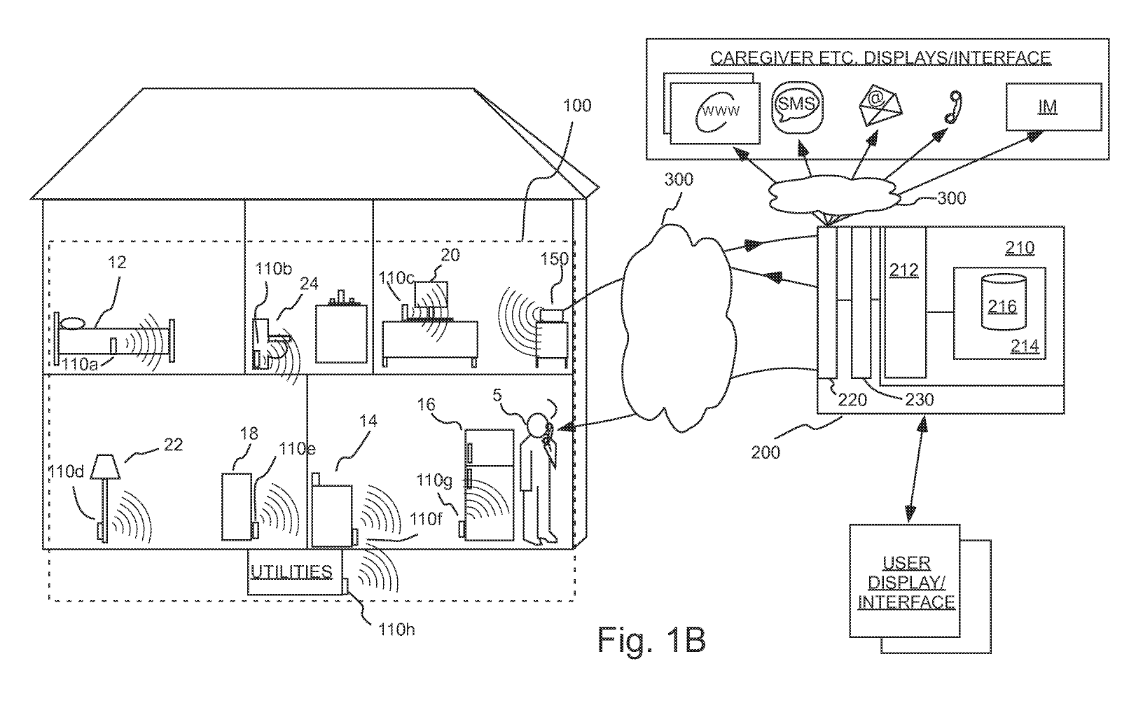

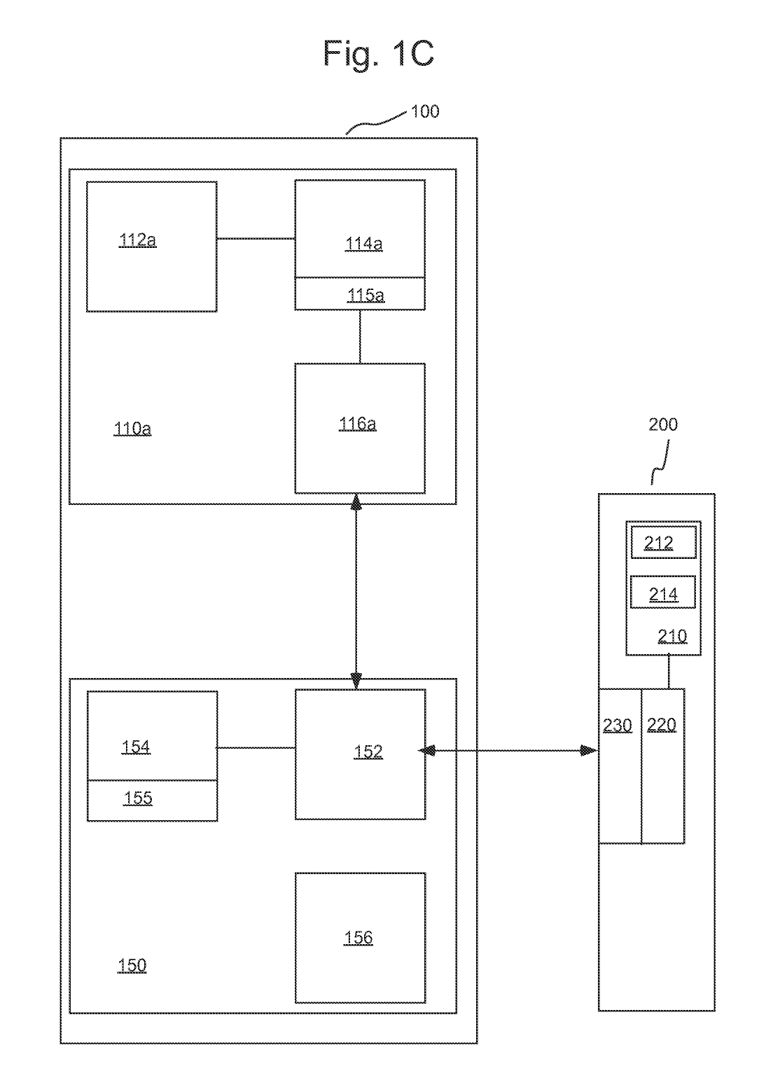

As described further below, while the monitoring of various devices and system in the vicinity of person 5 via a local system 100 (see FIGS. 1A through 1C) is real-time, the transmission of the collected data to a remote system 200, and ultimately to a caregiver (for example, a relative, friend, professional caregiver etc.), may be performed in a discontinuous or batch manner. For example, data of information of and/or a summary of the activity of person 5 for a given period (for example, a prior period of time of 24 hours) can be transmitted by local system 100 to remote system 200 for processing and/or analysis by remote system 200. Remote system 200 can received data from many local systems 100 regarding many different monitored persons 5. Local system 100 may, however, include a processing system including one or more processors programmed or adapted to determine if an emergency or exception event has occurred (based upon data from monitored devices and/or systems) which requires an expedited or unscheduled (for example, immediate) transmission or upload of data or information to remote system 200. Unscheduled uploads resulting from a determined emergency or exception event are sometimes referred to herein as a transmission or upload on exception. A determination as to whether to transmit or upload on exception is made by the processing system(s) of local system based upon preprogrammed rules or protocols. Upon transmission of data to remote system 200, a processing system of remote system 200 may make further determinations, and may, for example, notify a caregiver of the exception.

Depending upon the bandwidth of communication channels between local system 100 and remote system 200, the frequency of uploading collected data to remote system 200 may be increased. Moreover, upon occurrence of certain events such as emergency or exception events, certain data may be uploaded in a continuous or substantially continuous manner (for example, in real time). Furthermore, in the case of certain sensor systems (for example, sensor systems to monitor physiological parameters) for certain persons, it may be desirable to increase the frequency of uploads to remote system 200 or to transmit real time data in a continuous or substantially continuous manner in real time to remote system 200 even absent an exception event.

In a number of representative embodiments (as illustrated, for example, in FIGS. 1A through 1C), local system 100 of a monitoring system 50 hereof includes a plurality of sensor systems 110a, 110b, 110c, 110d, 110e, 110f, 110g etc. which communicate using a local network 120 such as a wireless local area network (LAN) with a local data communication device or hub 150. Local system 100 may, for example, be used in connection with a residence, a household, a abode or (generally) a space 10 in the vicinity of person or persons 5. In that regard, plurality of sensor systems 110a, 110b, 110c, 110d, 110e, 110f, 110g etc. may, for example, be operatively connected to or associated with furniture, utilities, equipment, devices, systems or appliances, such as one or more beds 12, ranges 14, refrigerators 16, televisions 18, computers 20, lamps/lights 22 toilets 24, a water utility inlet pipe etc. (see, for example, FIG. 1B). Data from sensor systems 110a, 110b, 110c, 110d, 110e, 110f, 110g etc. of local system 100 (which may be processed at least to some extent in local system 100) may be communicated, transmitted, or uploaded to remote system 200 via, for example, local data communication device 150. Remote system 200 may, for example, include a central processing system or a distributed processing system that may, for example, include one or more computers, servers or server systems 210. Computer(s), server(s) or server system(s) 210 may, for example, include one or more processors or processor systems 212 which are in communicative connection with one or more memory or storage systems 214 as known in the computer arts. Memory system(s) 214 may include one or more databases 216 stored therein. Local system 100 may communicate with a communication system or systems 220 of remote system 200 (for example, via local data communication device 150) through one or more wired or wireless communication channels 300 (for example, landline telephones, wireless telephones, a broadband internet connection and/or other communication channel(s)). Software stored in memory system(s) 214 or in one or more other memory system in communicative connection with processor(s) 210 may be used to process or analyze data from local system 100 and, for example, assist a caregiver with a long-term care plans, alerts, use of additional sensor systems etc.

In a number of embodiments, communication system 220 is in communicative connection with a gateway processor 230 of remote system 200. Gateway processor 230 may, for example, receive data from local data communication device 150 of local system 100, process that data (which may, for example, be received in binary file format) into a format readable by software executed by processor 210, and insert the processed data into database 216. In a number of embodiments, gateway processor 230 is adapted to receive data of a number of different types (for example, data regarding states from sensor systems 110a, 110b, 110c, 110d, 110e, 110f, 110g, data regarding medical device usage, etc.), provide initial processing of such data and route such data into a designated system such as into database 216.

Processing system(s) or server system(s) 210 of remote system 200 receive data from local system 100 and, for example, use/processes the data to implement a long-term care plan. Server system(s) 210 can, for example, apply predetermined rules and/or logic defining alert thresholds, alert methods, appointed caregivers, associated reports for trending etc. in implementing a care plan. Remote alerts can, for example, be activated in the case of predetermined events (or a series or groups of events) or at predetermined levels (as determined by monitoring system 50 on the basis of established rules and/or protocols) so that caregivers can respond in a proactive manner to changes in behavior and/or status of person 5. The alerts can, for example, be dispatched or made available to one or more caregiver (or others) via displays or interfaces in any number of ways through communications channel(s) 300 including, but not limited to interactive voice response or IVR, short message service or SMS, internet web pages, email, other internet communications (for example, instant messaging or IM), and/or smart phone/client applications. Compared to currently available monitoring systems, monitoring systems 50 hereof provide more proactive/timely alerts, while significantly reducing cost and complexity of installation. Caregivers can also transmit inquiries to remote system 200 via one or more communication channels 300 as described above to, for example, inquire of the current “status” of person 5. Such an inquire may, for example, result in a polling of sensor systems 110a, 110b, 110c, 110d, 110e, 110f, 110g etc. by local data communication device 150 for current or most recent data, which is the uploaded to remote system 200. Further, system 50 can transfer information to third parties (for example, physicians etc.) on the instructions of person 5 as part of an overall care plan. For example, a physician (or other authorized third party) portal can be provided as a module of communication system 220 of remote system 200.

As discussed above, sensor systems 110a, 110b, 110c, 110d, 110e, 110f, 110g etc. of local system 100 may, for example, be used in connection with person(s) 5, space 10, a variety of medical devices, appliances, equipment, utilities etc. to monitor the person's wellbeing by, for example, monitoring activity/inactivity of person 5. Unites States Patent Application Publication No. 2012/0056746, the disclosure of which is incorporated herein by reference, provides a description of a number of representative devices and/or systems that may be monitored and representative sensor types for use in monitoring such devices and/or systems. Information or data can also be garnered from systems external to local system 100 or to space 10. For example, temperature data, weather data etc. can be measured or downloaded from various sources available on networked (for example, via the internet) databases.

As illustrated for representative sensor system 110a in FIG. 1C, sensor systems hereof may include at least one sensing or measuring system 112a, at least one processing system or processor 114a (for example, a microprocessor), at least one a memory system 115a and at least one communication system 116a. Sensor system 112a is adapted or operable to measure one or more variables associated with, for example, a state or change in state of a monitored system. Such states are predefined states or conditions which are dependent upon a system being monitored. Data measured and communicated to local data communication device 150 may, for example, include a time of onset of a state (that is, a time of change from a previous or first state to a latter or second state) and data related to the duration of the state (for example, a time of cessation of a state and/or duration of the state). Processor 114a may, for example, perform operations on data received from sensing system 112a, in a manner predetermined by programming therefor which may be stored in memory system 115a. Processor 114a communicates information or data to communication system 116a, which is adapted or operable to transmit the information or data to, for example, local data communication device 150.

Local data communication device 150 includes at least one communication system 152 which communicates (either unidirectionally or bidirectionally) with communication system 116a of sensor system 110a. In a number of embodiments, each of sensor communication system 116a and communication system 152 includes a wireless transceiver for wireless communication (for example, using a ZIGBEE® or other wireless communication protocol). In the illustrated embodiment, local data communication device 150 further includes one or more processors 154 and one or more memory systems 155. Processor 154 may, for example, be programmed or adapted (via programming stored in memory system 155) to process (or to further process) data from sensor systems 110a, 110b, 110c, 110d, 110e, 110f, 110g etc. Processor 154 may further be programmed or adapted to initiate signals to be transmitted to sensor systems 110a, 110b, 110c, 110d, 110e, 110f, 110g etc. such as wake up signals, data polling signals etc. Moreover, processor 154 may further be programmed or adapted to control communications between one or more communication modules of communication system 152 and one or more modules of communication system 220 of remote system 200. Although a separate local data communication device 150 is provided in a number of embodiments hereof, the functionality of local data communication device 150 can be performed, in whole or in part, by one or more of sensor systems 110a, 110b, 110c, 110d, 110e, 110f, 110g etc.

In a number of currently available monitoring system for various uses, one or more monitoring devices stream analog-based data to a remote or central server or software device which then converts the streamed data to meaningful information. Analog data is by its nature memory intensive and network bandwidth intensive, thereby increasing the cost of transmitting the data, slowing the transmission of the data, and limiting/consuming network bandwidth.

In several embodiments of the methods and systems hereof, plurality of sensors 10a, 10b, 10c, 10d, 10e, 10f, 10g, etc. as described above monitor a set of variables or parameters indicating state(s), changes in state and/or a lack of a change in state (for example, indicating operational use or disuse) of, for example, household devices or systems, household appliances, utilities (for example, water, electricity, sewage, gas, fuel oil etc.), furniture (or example, beds, chairs etc.) medical devices and/or any other devices or systems. Sensors 10a, 10b, 10c, 10d, 10e, 10f, 10g, etc. collect analog data which are recorded (or converted into) event or state-based data, which can be represented as discrete values. Data of states and changes of states (as defined in monitoring system 50) of a monitored device or system may, for example, be generated to provide a state history in which, for example, defined states and durations of such defined states over time are set forth for a period of time. Rather than transmitting a stream of analog operational or status data, state-based data or values which, for example, correspond to the state or state history of a monitored device or system (for example, time of use/state change, duration of state, level of use etc.) for a period of time are transmitted in a noncontinuous, discontinuous or batch manner at intervals spaced in time (although not necessarily at regularly spaced intervals) to communication system 20 of remote system 200. In that regard, the data may be transmitted by communication system 152 of local data communication device 150 via one or more of communication channels 300 (for example, via telephone, internet etc.) to communication system 220 of remote system 200. The data may, for example, be transferred periodically (for example, hourly, daily etc.). Different data or values may, for example, be transmitted with different time intervals or frequencies depending upon the nature of the underlying event(s) or values as set forth in predetermined rules.

As described above, some processing of data occurs in a processing system of local system 100. Such processing may, for example, occur in a processor or processors of one or more of sensors 10a, 10b, 10c, 10d, 10e, 10f, 10g, etc. (for example, in processor 114a of sensor system 110a), in a processor or processors 154 of local data communication device 150 and/or in one or more other processors of local system 100 before transfer of data to the remote system 200. In a number of embodiments, local data communication device 150 serves as a repository for all information coming from sensors 10a, 10b, 10c, 10d, 10e, 10f, 10g, etc. Additional processing in processor 154, when effected, may, for example, include: comparing of values with prior average values, evaluation of combinatorial events from more than one sensor or sensor system to infer or determine situations or events not necessarily inferable or determinable from a single sensor or sensor system, and the transmission of data/information to remote system 200. In that regard, a plurality of sensors working in concert as part of a larger network monitoring system and designed to upload data on, for example, a predetermined period leave open the possibility that a meaningful event can occur in space 10 that does not generate an alert or alerts from remote system 200 until the data is uploaded to remote system 200. This delay can reduce the effectiveness of monitoring system 50 and potentially result in negative clinical benefits to person 5 if it results in delay of an appropriate reaction to a clinical need or problem. Continuous streaming of analog data may prevent such negative clinical outcomes, however, as described above, transmission of real time streams of monitored data is expensive, requires substantial network bandwidth and requires a substantial amount of memory.

In a number of embodiments, transmission of data to remote system 200 occurs on a regular, periodic basis and/or on an unscheduled or exception basis. In that regard, exceptions or triggering events defined by predetermined states or state changes, groups of states or state changes, events, thresholds, or business logic, are established which, when determined to be in existence (using defined rules), trigger an automatic upload of data to remote system 200 regardless of predetermined upload cycles. Such exceptions or triggering events result in more timely and effective monitoring of person 5. Software or logic to determine such an exception or a triggering event can, for example, be resident on a sensor system, on local data communication device 150 and/or on a separate processor system of local system 10. Thus, an exception occurs when a condition is determined to exists (via processing/analysis of sensor data in local system 100) which requires expedited or immediate attention from remote system 200.

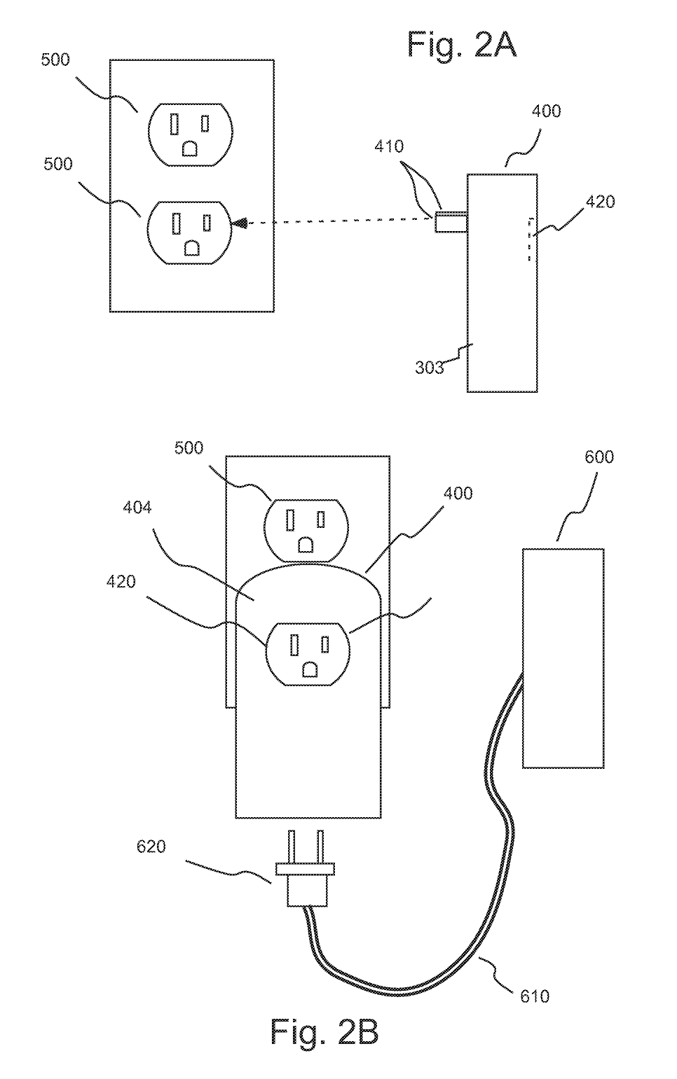

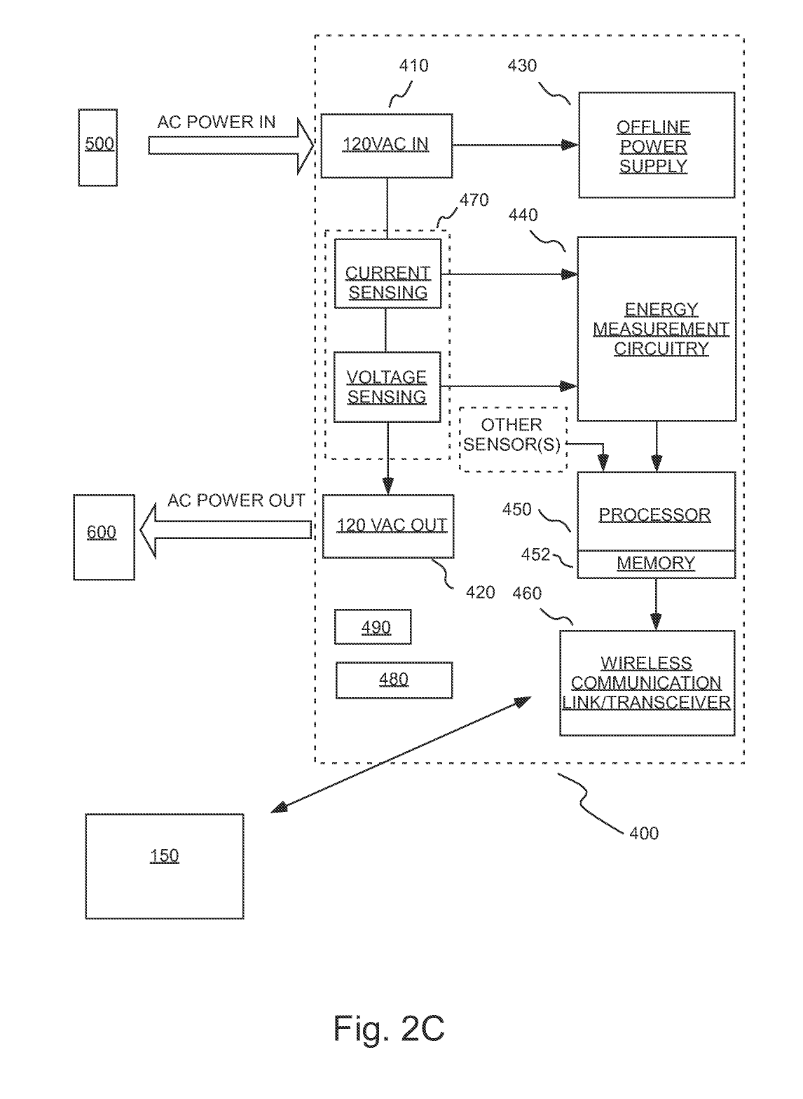

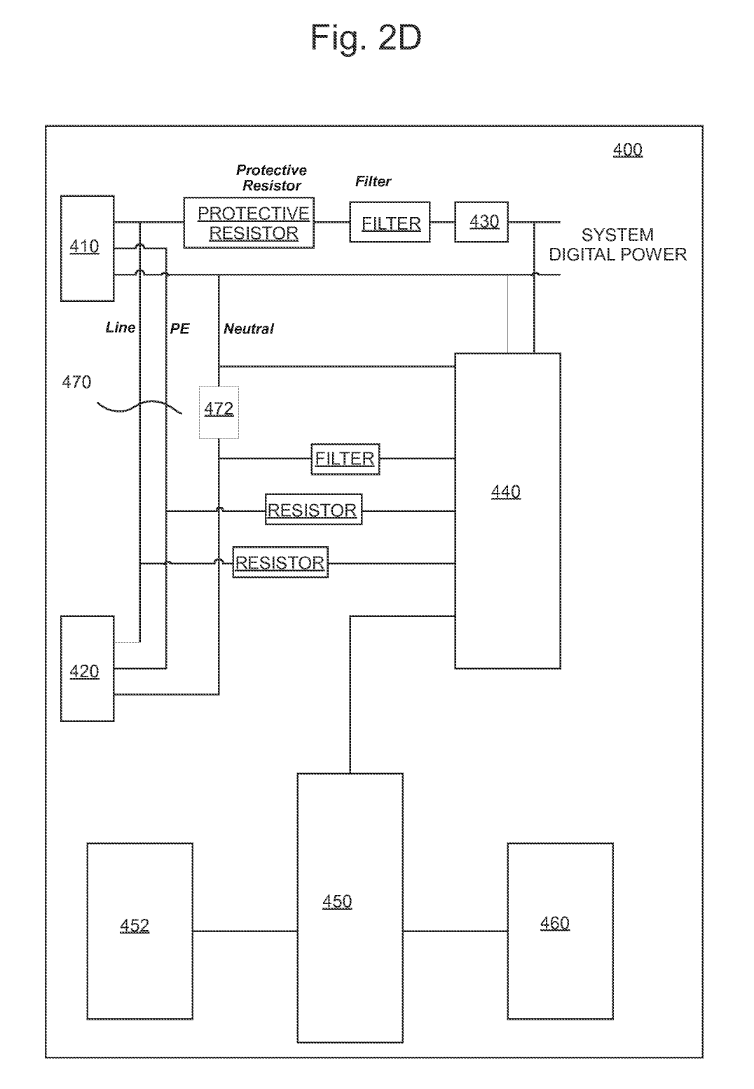

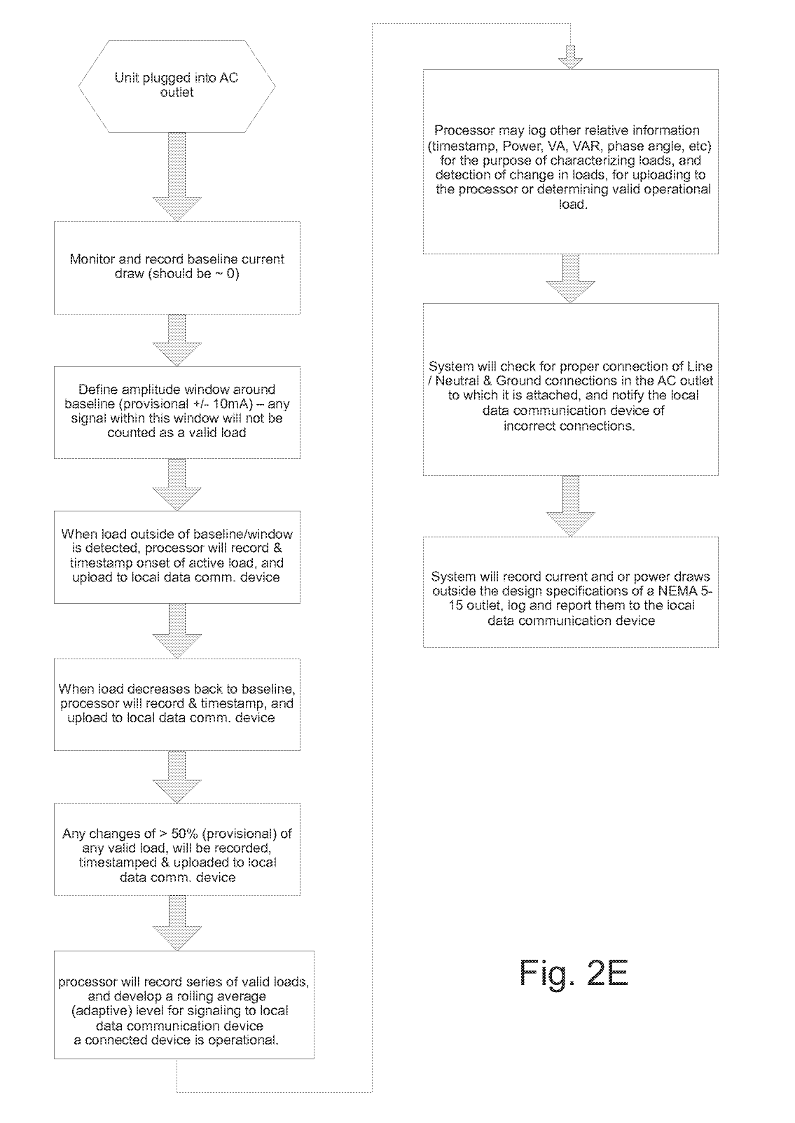

Several types of representative sensor systems for use in the systems hereof are discussed in further detail below. One type of sensor system used in the systems hereof is an energy sensor system that can be used in connection with electrically powered devices attached to an electrical outlet in space 10. One or a plurality of sensor systems 10a, 10b, 10c, 10d, 10e, 10f, 10g, etc. may be an energy sensor system as describe herein. A representative embodiment of a modular or universal energy sensor system 400 for use with electrically powered devices is, for example, illustrated in FIGS. 2A through 2D. Energy sensor 400 is also described in Unites States Patent Application Publication No. 2012/0056746. Energy sensor system 400 may, for example, be used in connection with monitoring any one of many electrically powered devices (for example, televisions, radios, computers, kitchen appliance, other appliances etc.). For example, energy sensor system 400 can be used in connection with an device or system operating within a defined range of voltages and/or a defined range or currents. Energy sensor system 400 may, for example, be plugged into a standard NEMA wall power outlet or receptacle 500 via plug contacts 410 extending from a rearward surface of a housing 404 of energy sensor system 400. Energy sensor system 400 may also include a standard NEMA outlet 420 to receive a standard NEMA plug 620 of a power cord 610 from a monitored device 600 (see FIG. 2B), such that the current flows through the circuitry (see FIGS. 2C and 2D) of energy sensor system 400. The existence, magnitude, phase angle, voltage etc. of current draw through power cord 610 indicates, for example, that monitored device 600 is in use, the duration of use, the nature of the use etc.

Energy sensor system 400 may, for example, be standardized for universal use in connection with devices using, for example, 110 volt power. As described above, energy sensor system 400 may be plugged into any standard household AC outlet, socket or receptacle 500, and may receive standard NEMA 5-15 power plug 620 from cord 610 connected to any device 600 to be monitored. As illustrated in FIG. 2C, AC power is supplied to energy sensor system 400 via, for example, standard NEMA 5-15 power plug 410. AC power is supplied from energy sensor 400 to monitored device 600 via, for example, standard NEMA 5-15 power socket 420.

Power for the circuitry of energy sensor system 400 may, for example, be derived from an off-line switching power supply 430. Power supply 430 may, for example, include an integrated circuit, IC or chip such as a Linkswitch LNK-305 series IC available from Power Integrations of San Jose, Calif. and associated passive components, which generate a voltage of, for example, −3.3 VDC with respect to an AC neutral line. In the illustrated embodiment, power supply 430 powers an energy monitoring chip 440, a computer processor 450 (for example, a microprocessor) and a wireless communication link or module 460.

A sensor 470 may, for example, include a low value (for example, 0.004Ω nominal) series ohmic shunt 472 which is placed in series with the neutral connection between NEMA input plug 410 and NEMA output socket/outlet 420, to which monitored device 600 is connected. A voltage is developed across the shunt resistor, which is proportional to the current flowing through it. The measured current may be used for the calculation of current draw, power, and/or other parameters of monitored device 600. Voltage sensing of the AC circuit being monitored may, for example, be accomplished via a network of high-value resistors which are connected to line, neutral and ground. The measured voltage may be used to determine voltage, phase angle, power factor and other parameters of interest of the power source and effects thereon by the connected load.

In a number of embodiments, a Maxim 78M6612 power and energy measurement integrated circuit, chip or system-on-a-chip available from Maxim Integrated Products, Inc. of Sunnyvale, Calif., monitored the voltage and current delivered to monitored device 600 through the above-described electrical networks, and processed the information to generate digital information including, but not limited to, AC voltage, current, power, VA, phase angle and other parameters which characterize the operational status or state of monitored device 600. Operation of the Maxim 78M6612 power and energy measurement integrated circuit is described in the 78M6612 Single-Phase, Dual-Outlet Power and Energy Measurement IC Data Sheet, Maxim Integrated Products, Inc. (June 2009), the disclosure of which is incorporated herein by reference. Processor 450 is, for example, a Microchip PIC-series PIC24FJ128GA006-I/PT microprocessor available from Microchip Technology, Inc. of Chandler, Ariz. Operation of the Microchip PIC-series PIC24FJ128GA006-I/PT microprocessor is described in the PIC24FJ128GA010 Family Data Sheet, Microchip Technology, Inc. (2009), the disclosure of which is incorporated herein by reference. Processor 450, may for example, perform operations on the electrical data received from the energy monitoring chip 440, as, for example, specified in the operational description below and the flowchart of FIG. 2E. Processor 450 relays information via, for example, wireless communication link 460 (which may, for example, be an RF connection using, for example, Zigbee protocol) to local data communication device 150. A wireless RF communication connection may, for example, be established via a Microchip MRF24J40MA-I/RM Zigbee module available from Microchip Technology, Inc., which is controlled by processor 450. Operation of the Microchip MRF24J40MA-I/RM system is described in MRF24J40MA Data Sheet, Microchip Technology, Inc. (2008), the disclosure of which is incorporated herein by reference. Communication link 460, for example, uploads the information derived from energy monitoring chip 440 under control of processor 450, in accordance with defined variable changes corresponding to defined changes of state of monitored device 600. Sensor or sensing circuitry 470, wireless communication link 460, processor 450, energy measurement circuitry 440, and power supply 430 are integrated into a single unit within housing 404.

Devices such as monitored device 600 may, for example, operate from a nominal 110 VAC source, and may, for example, be limited in current draw to approximately 15 A. In a number of embodiments, the minimum current draw which may be resolved is approximately 0.010 A. One or more indicators 480 (see FIG. 2C) such as one or more lights may be provided to indicate different operational states of energy sensor 400, including, but not limited to, communication (RF) pairing, ready for operation, power available and/or fault status. A switch 490 (see FIG. 2C) may be provided for a user to, for example, initiate an RF pairing process, wherein energy sensor 400 is associated with a specific central data collection point or local data communication device 150 operating on the same RF channel. Switch 490 may, for example, be mechanical, magnetic or operated by other inputs. Energy sensor system 400 may, for example, include one or more magnetic reed, capacitive or other switches for the purpose of performing various functions, including, but not limited to the initiation of RF pairing operations.

As set forth in the flowchart of FIG. 2E, energy sensor system 400 may, for example, monitor and record a baseline current draw (for example, approximately 0 A in a number of devices). As described above, an amplitude window around the baseline (such as approximately +/−0.010 A or 10 mA) may be defined. Any signal within the defined amplitude window will not be considered a valid load. When a load is outside of the baseline window is detected, processor 450 may, for example, record and timestamps the onset of the measured current/active load. This information may be uploaded to local data communication device 150. When the measured load decreases to the baseline load, processor 450 records and timestamps the decrease in load. This information may also be uploaded to local data communication device 150. In a number of embodiments, any changes of a certain threshold (for example, 50% or greater) of any valid load are recorded, time-stamped and uploaded to local data communication device 150. Processor 450 may, for example, record a series of valid loads and develop a rolling average (adaptive) level for signaling to local data communication device 150 that monitored device 600 or other connected device is operational. As described above, processor 450 may log other relevant information (for example, timestamp, power, VA, VAR, phase angle, etc.) to characterize loads and detection of changes in loads for uploading to local data communication device 150 and/or for determining valid operational load.

Energy sensor system 400 is adapted to or operable to monitor an unknown variety of devices which may, for example, be found in space 10 (for example, a home). Because of this uncertainty regarding the status of a device in terms of, for example, current draw during various states (for example, when “on”, “asleep”, “off” or in another mode or state), energy sensor system 400 monitors various current or power draws of the device over a predetermined period (for example, in the range of approximately 3-7 days). As energy sensor system 400 monitors the power or current draw of the connected/monitored device, it may, for example, record minima and maxima of those values. From the minima and maxima data points, a reference in between those points may be generated or determined that is set as the decision point for determining whether a device is, for example, in an “on” state, in an “off” state or in another defined state. This methodology is in contrast to a methodology in which a fixed threshold is established for determining operational status or state. Many devices continue to draw current even while in an “off” state (in terms of the user's perception) and any preset or fixed threshold runs the risk of incorrectly determining the status of a connected device. Energy sensor system 400 continuously record and updates the determined threshold, making energy sensor system 400 usable even if the connected device is changed.

In a number of embodiments, after a device such as device 600 is connected to energy sensor system 400 and a nonzero load is detected, energy sensor system 400 begins recording measured current values. After a defined period (for example, 72 hours), energy sensor system 600 may, for example, determine the standard deviation of the measured values, and, if exceeding a preset or determined amount, average the group of values in the high range, and average the group of values in the low range. Energy sensor system 600 may then establish a threshold using an equation such as, for example, avg low+(avg high−avg low)/5 or a similar equation, and use the calculated threshold to determine and record states (for example, on or off states). As the values are continuously recorded, the averages and determined threshold may update, so that energy sensor system 400 dynamically adapts.

In general, energy sensor system 400 may send status of electrical power, and/or status of monitored device 600 in real-time to local data communication device 150, or timestamp and store such or similar information for transmission at a predetermined or externally requested time. With respect to the status of electrical power, energy sensor system 400 can readily detect an incipient loss of power and transmit data regarding such an event to local data communication device 150. Likewise, energy sensor system 400 can detect resumption of interrupted power and transmit such data.

Energy sensor system 400 may also check for proper connection of the line, neutral and ground connections in AC outlet 500 to which it is attached and notify local data communication device 150 or incorrect connections. Energy sensor system 400 may also record current, power draws and/or other measure variables outside the design specifications of a NEMA 5-15 (or other specified) outlet and log and report such information or data to local data communication system 150.

In the systems and methods hereof, use of a monitoring technology to track usage of a variety of household electrical items and/or appliances is simplified with the use of a universal sensor system such as energy sensor system 400. Because energy sensor system 400 may be used in connection with more than one type of device, the identification of the device being monitored may be desirable.

If the device being monitored is assigned or identified incorrectly, false positives or negatives in uploads on exception and/or alerts generated by remote system 200 may result, thereby reducing the effectiveness of monitoring system 50 in monitoring the wellbeing of person 5 Energy sensor system 400 and/or other universal sensor system may, for example, be provided with a selector via which person 5, a caregiver, an installer or other person identifies the type of device to which the sensor system is attached. However, such a selector leaves open the possibility of human error.

Processor 450 of energy sensor system 400 (and/or one or more processors in communication with energy sensor system 400) may, for example, use the existence of unique current draw and/or other characteristics to determine if energy sensor system 400 is being used in connection with a particular device or system. Processing system 450 of energy sensor system 400 may, for example, execute one or more algorithms to determines operational status of a connected device. Each monitored device or system has unique current draw and/or other electrical characteristics which may be used to either identify the device or system, or, at a minimum, rule out certain other possibilities. Examples of parameters to be monitored to determine an attached device include current frequency, current amplitude, phase angle, Fourier transform pattern, real power, reactive power, imaginary power, power factor etc. Algorithms to identify and/or monitor a device may, for example, consider sleeping modes or states, energy saving modes or states, etc. and dynamically adapt to different devices automatically. Operating and/or non-operating electrical characteristics of a monitored device or system can, for example, be compared characteristics of known electrical devices or systems for the purpose of determining or inferring the type or nature of an otherwise unknown connected device. Stored equations or look-up tables of known electrical device characteristics can, for example, be stored in memory system 452 of energy sensor system 400 or in a memory system in communicative connection with energy sensor system 400 for comparison to measured characteristics of a monitored device or system.

After determination of the type, nature or identity of a connected/monitored device, a logic check can, for example, be performed to ensure that current draw and/or other characteristics are consistent with the device assigned to a given monitor. If the current draw and/or other characteristics do not match the assigned device, the associated data can, for example, be flagged as suspect. Such a device recognition system can, for example, reduce errors and simplify installation. The logic check can, for example, using a processing system of local system 100 and/or a processing system of remote system 200 (for example, using energy sensor system 400, local data communication device 150, server system 210 and/or another processing system).

Variables other than can electrical energy-drawing variables can, for example, be monitored by energy sensor system 400 via one or more other sensors (illustrated schematically in FIG. 2C). For example, energy sensor system can also include one or more other sensors to monitor environmental signals such as ambient light, motion, acoustic noise, temperature, humidity and/or other environmental conditions. Such conditions can, for example, effect current- or other energy-related variables measured by energy sensor system 400 and may, for example, be used for the evaluation of circuit performance or ambient environmental conditions and/or correction of measured energy-related variables.

In the case of devices or appliances that use current other than 110 volt current (for example, an electric range), a sensor system other than energy sensor system 400 may be used. For example, an impedance sensor system may be used to measure or determine states, changes of state etc. For example, a current sensitive/impedance sensor system can be placed in operative connection with (for example, fit around) the power cord of the electric range or other device. The existence of current draw through the power cord will, for example, indicate that the range or other device/system is in use, and for what duration.

In the case of a number of devices, changes in state secondary to the primary function of the device (for example, from one or more subsystems of the device) can be monitored to measure changes in state of the device. To monitor refrigerator usage, for example, a light-sensitive sensor system or a current- or energy-based sensor system (for example, as described above) in electrical connection with the refrigerator/refrigerator light bulb may be used to monitor state changes of the refrigerator. For example, a current sensitive sensor system may be used in connection with the electrical outlet of the refrigerator light. The existence of current draw through the refrigerator light bulb indicates that the refrigerator door has been opened, and for what duration.

Various sensor systems can also be used to measure utility usage such as water, heating and air conditioning, sewage etc. By, for example, measuring the water intake of a household (or other abode) at the input pipe of the household, a remote caregiver has the ability to track water usage associated with monitored person 5 using the bathroom, taking showers, washing dishes, washing clothes, etc. These behaviors are, in part, an indication of the wellbeing of monitored person 5. Water usage sensing and analysis is, for example, described in U.S. patent application Ser. No. 13/631,964, filed Sep. 29, 2012 and PCT International Patent Application No. PCT/US2012/058162, filed Sep. 29, 2012, the disclosures of which are incorporated herein by reference.

In a number of embodiments, one of sensor systems 10a, 10b, 10c, 10d, 10e, 10f, 10g etc. is a temperature sensor which is used to measure/determine, for example, kitchen activities (or lack of activities) related to, for example, use of a monitored system such as a range (or stove) and/or oven via which food is heated or cooked. For example, a temperature sensor may be integrated into a system which is designed to be positioned in the vicinity of a stove or range surface. Such a system may, for example, be placed on a countertop or mounted underneath a cabinet adjacent to a stove or range surface. In a number of embodiments, the temperature sensor or sensors may, for example, be located somewhere between 6 and 18 inches above a cooktop/stove/rangetop surface in the vertical direction, and with a lateral offset (for example, 6 to 18 inches) from the convective heating which would be present directly over a cooking surface.

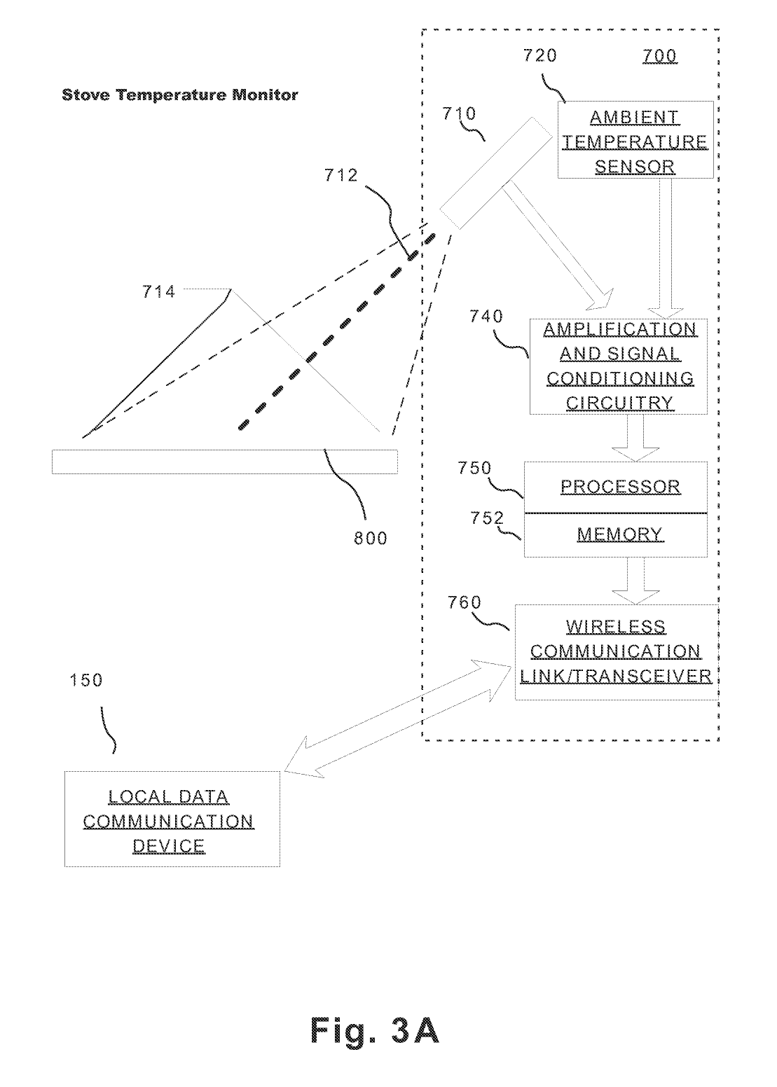

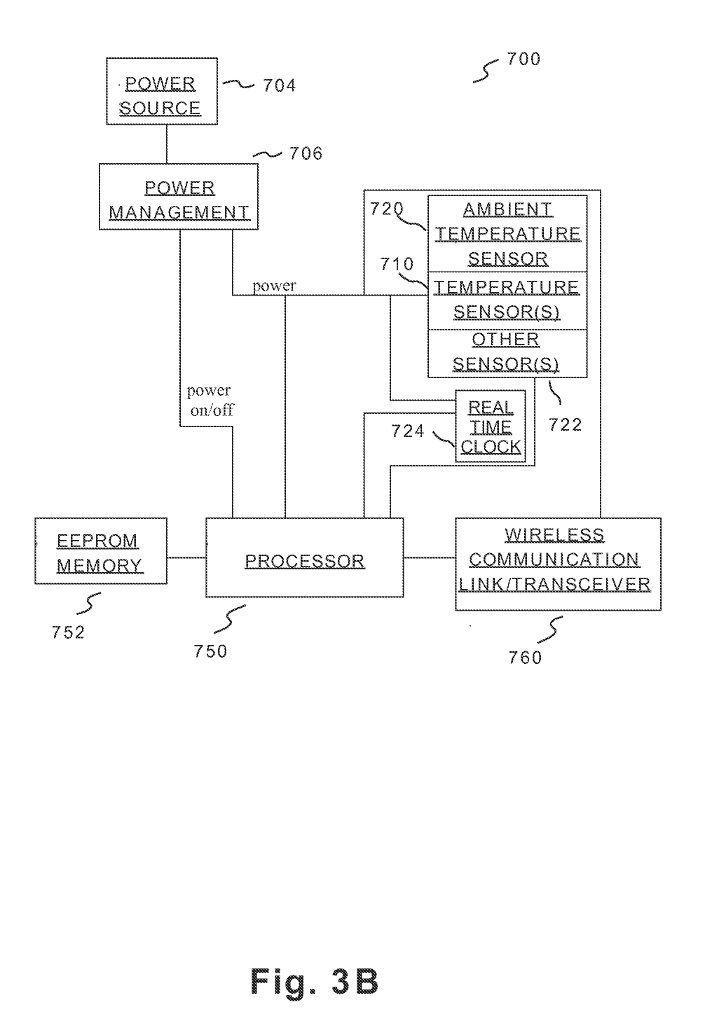

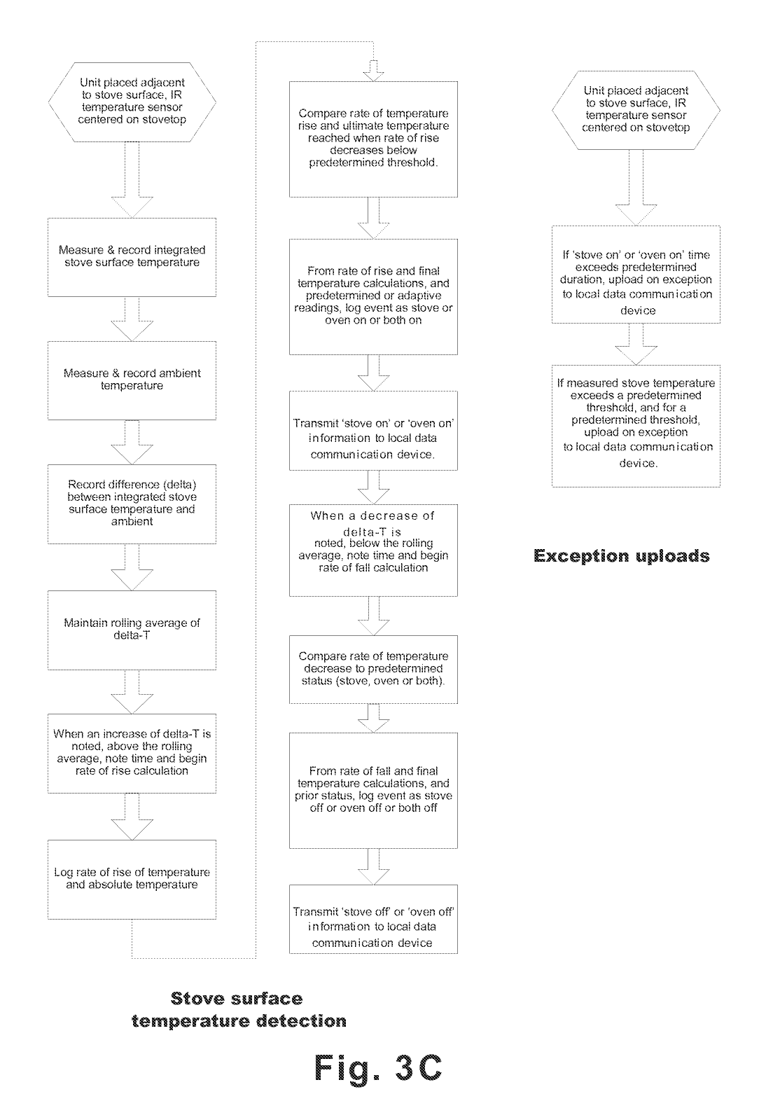

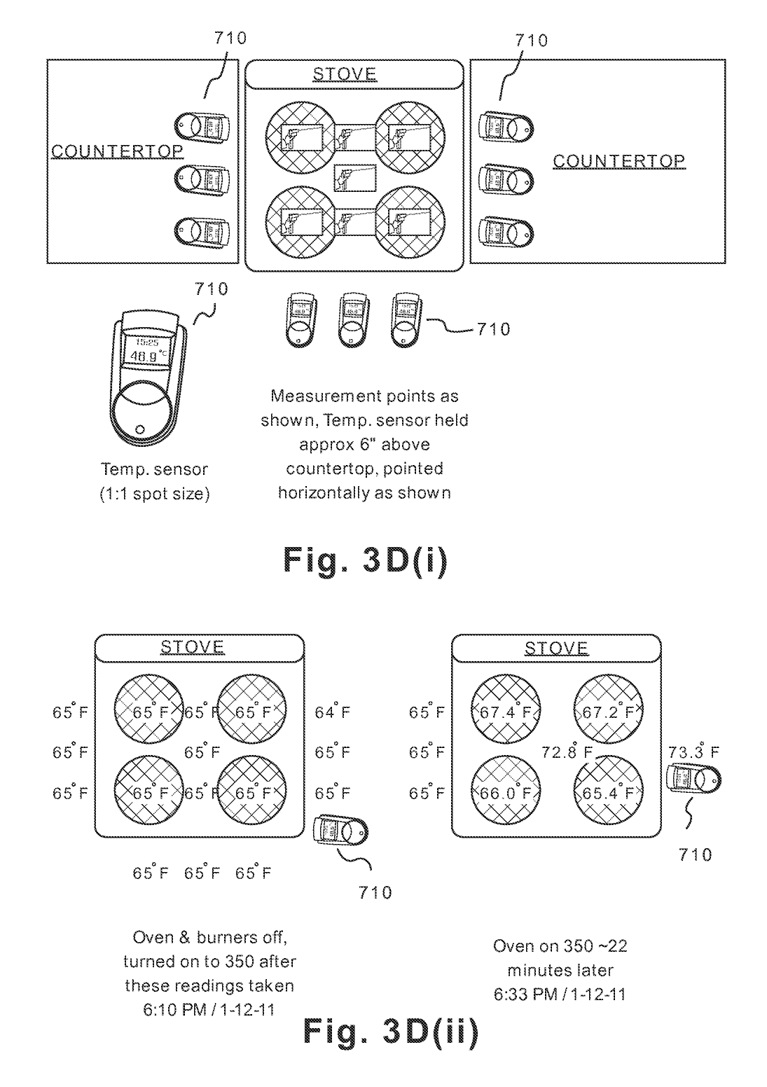

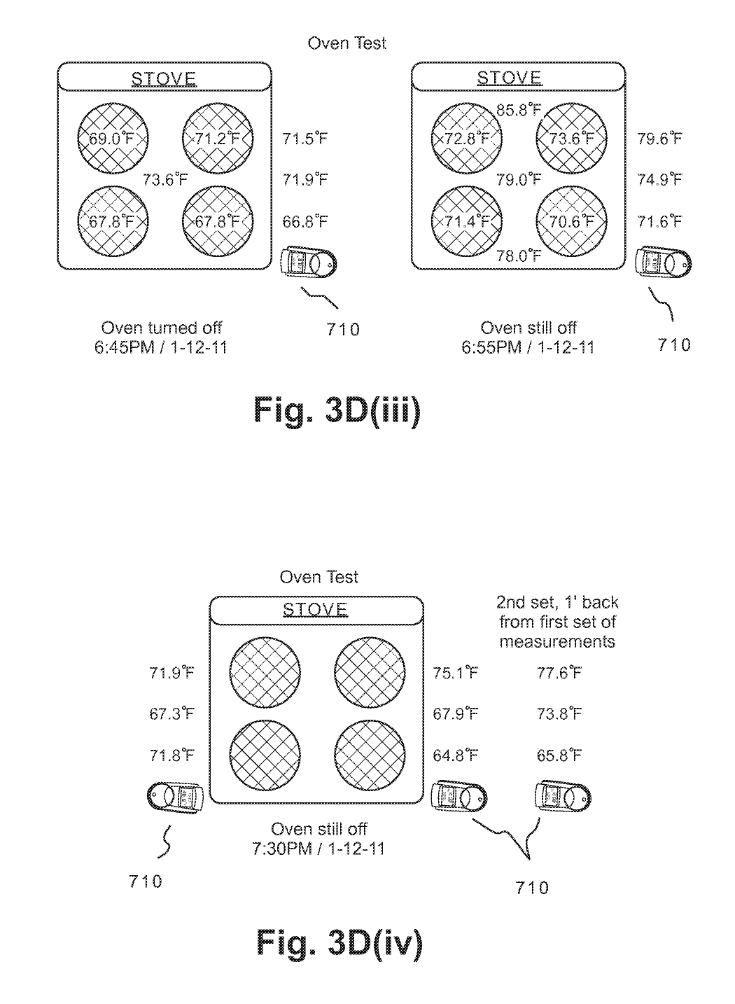

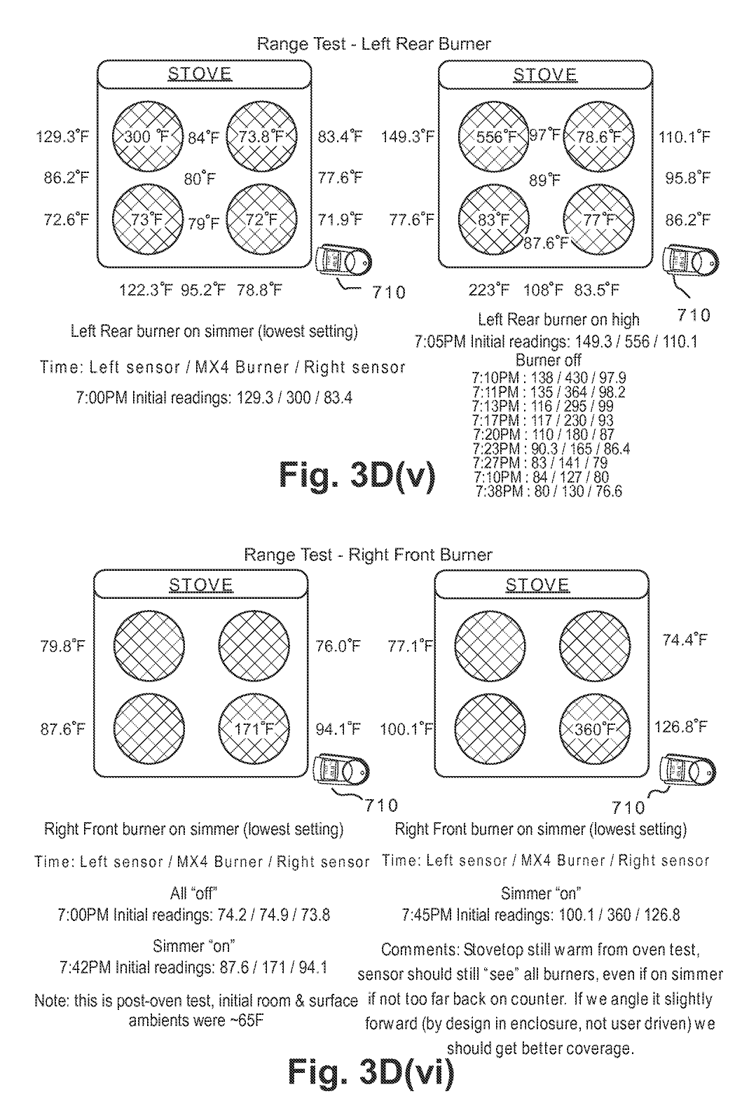

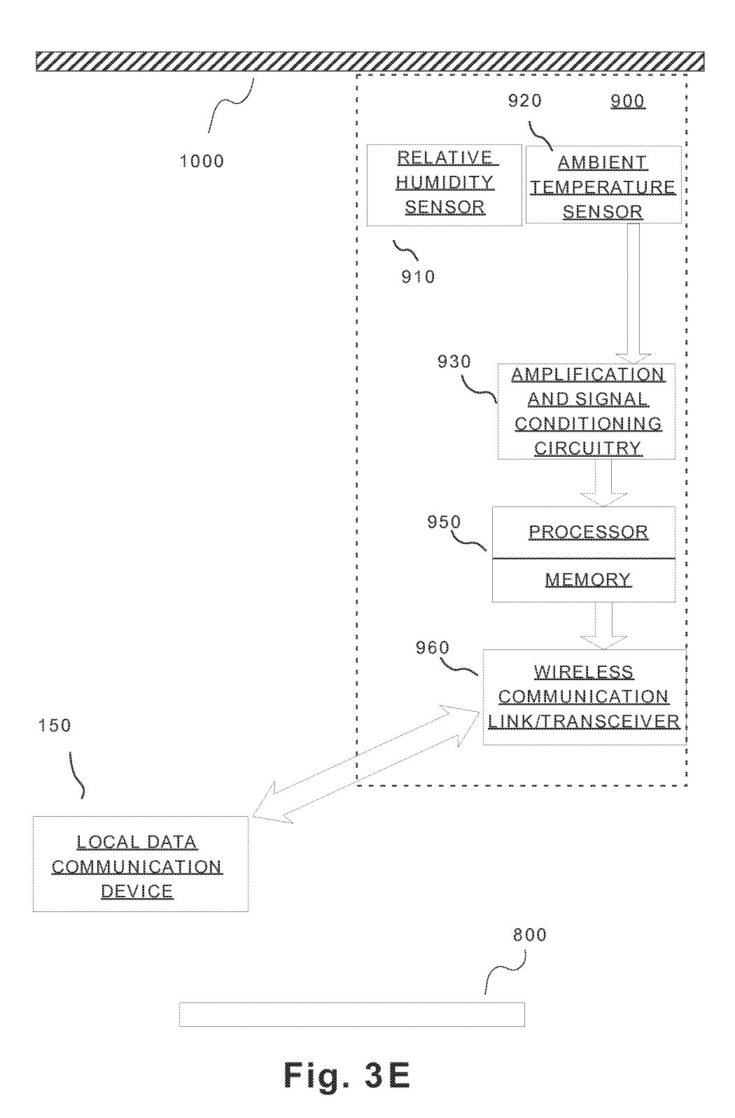

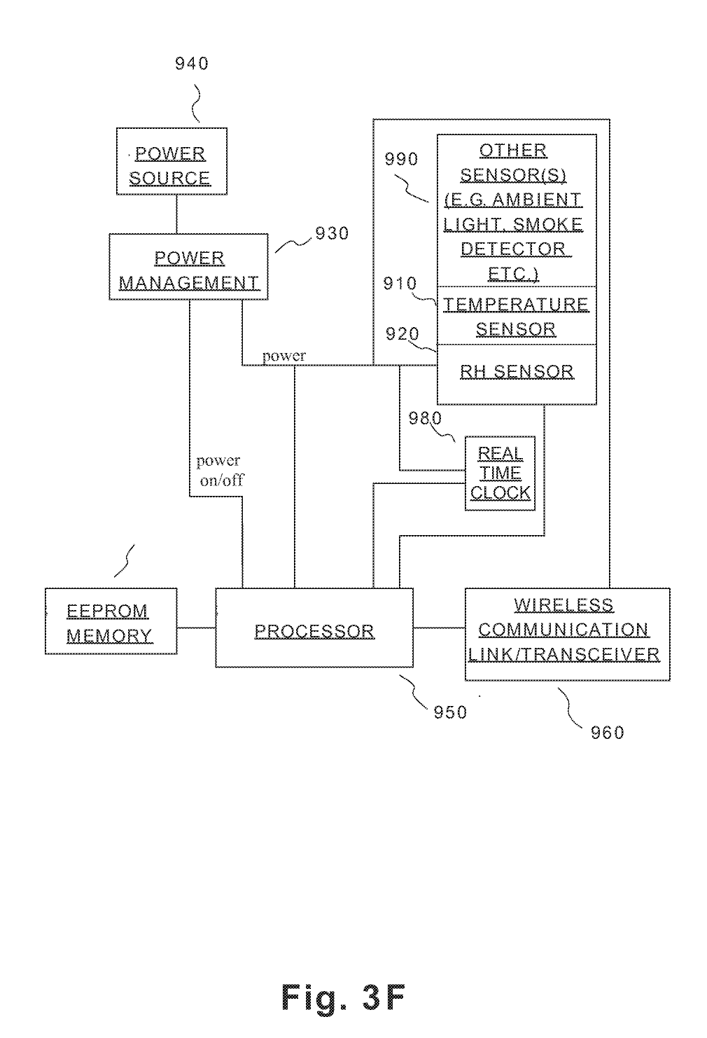

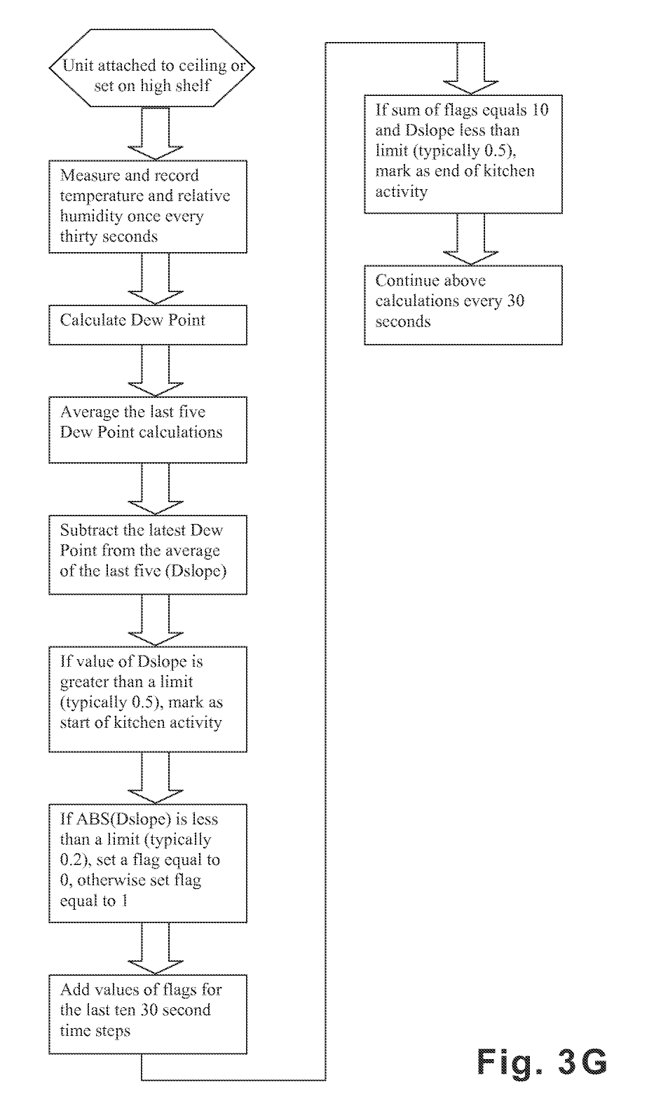

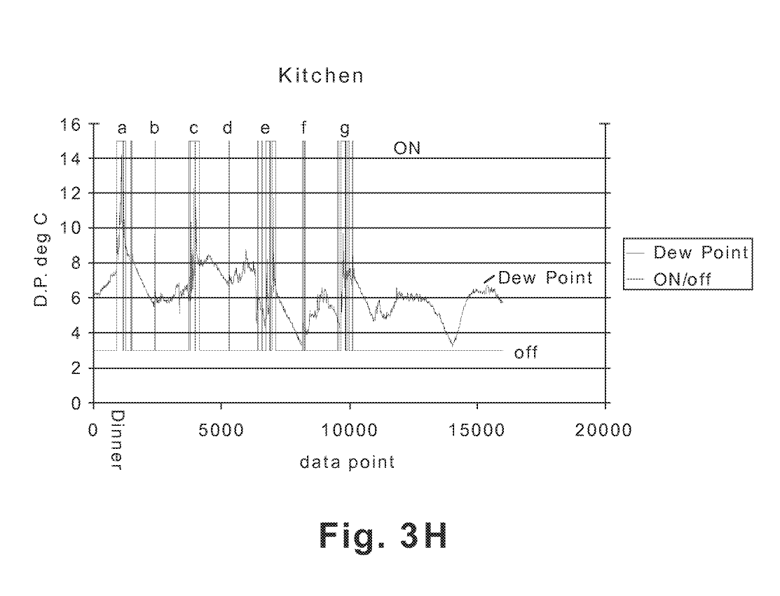

FIGS. 3A and 3B illustrates an embodiment of a temperature sensing system 700 including an infrared (IR) temperature sensor 710 (or other sensor or array of sensors) that is adapted to measure temperature over a predetermined or defined field of view or area. IR temperature sensor 700 may, for example, be mounted on an adjustable head, which may be aimed at, for example, the center of a cooktop surface 800, assisted by a visible (for example, red) laser diode represented by dashed line 712. A user may, for example, be instructed to move the head of sensor 710 until a red dot from laser 712 is roughly centered on cooktop surface 800. A diffuser may, for example, be used to provide an integrated or averaged temperature over at least a portion of the area of surface 800. For cooktops, stoves or ranges having a width or area in excess of a predetermined or defined width or area (for example, having a width in excess of 30 inches or an area in excess of 900 in²), additional temperature sensors may be required to provide proper coverage of the overall required field of view or area. Additional sensors may, for example, be mounted on opposite sides of cooktop surface 800 to expand the coverage width.

In general, most stoves with an oven placed underneath have a vent which opens at the rear edge of the cooktop surface. Sensor 710 measures the temperatures of objects in its area or field of view (represented by dashed lines 714). The vented heat from an operating oven, coupled with the conducted heat from an oven up through the cooktop, will raise the temperature of cooktop surface 800 above ambient, such that it may be detected by IR sensor 710.

The rate of rise of cooktop surface 800 will typically be slower for an operating oven underneath than for an operating burner on top of cooktop surface 800. Sensor system 700 may, for example, integrate (for example, average) the temperature of all objects in its field of view 714, so certain objects on cooktop surface 800 can alter the timing characteristics of the measured temperature rise. For example, an open burner in direct view of IR sensor 710 may provide the fastest rate of rise, followed, for example, a burner occupied by an article of highly thermal-conductivity cookware with little or no food or liquid therein. Items with larger thermal mass, including but not limited to; cast iron cookware, or general cookware with large quantities of food or liquid within, will required more time to heat. Final temperature, as determined, for example, by a decrease in rate of temperature rise, may serve to provide additional differentiation between, for example, an operating oven and a large stockpot of water (with the latter reaching a higher ultimate temperature as measured by IR sensor 710).

Sensor system 700 may, for example, be used with electric or gas (for example, natural gas or propane gas) stoves/ranges. Moreover, sensor system 700 may also be used in connection with the operation of additional common household devices which generate heat, including, but not limited to: griddles, countertop toaster ovens, rice cookers, crockpots, space heaters, freestanding stoves or fireplaces. Newer technology cooking devices, including induction ranges, may be detected indirectly through the heating of a vessel of the proper material and construction being placed upon them. Without such a vessel (in general, any ferritic-based material), an induction cooktop can be “on”, but not generate any heat.

Ambient air temperature detection may, for example, also provided by a temperature sensor 720, which may, for example, be shielded from direct radiated thermal energy. The output signal from ambient temperature sensor 720 may, for example, be used to enable sensor system 700 to distinguish normal variation of object temperature throughout a household during the day and night.

Additional software discrimination may, for example, be used to recognize temperature variation which might be induced on a cooktop by an external (non-cooking) source, such as sunlight illuminating the surface and gradually raising its temperature or by an HVAC (heating, ventilation and air conditioning) system. This may, for example, be performed locally in system 700, or may alternatively or additionally be performed remotely at a data collection point such as local data communication device 150, using data from other sensors (for example, temperature sensors in other rooms) or from geographic and meteorological sources, including those available online (for example, via the internet and/or other network). Periodicity of such external signals may also be used to dynamically alter the sensitivity of sensor system 700.

In the illustrated embodiment, sensors 710 and 720 are in communicative connection with circuitry 730 to, for example, provide amplification and signal conditioning. In the illustrated embodiment, a computer processor 750 (for example, a microprocessor), associated memory 752, and a wireless communication link or module 760 (as, for example, described in connection with energy sensor 400) to communicate with local data communication device 150. Processor 750 may, for example, be a Microchip PIC-series microprocessor available from Microchip Technology, Inc. of Chandler, Ariz. Processor 750, may for example, perform operations on the temperature data received from the sensors 710 and 720, as, for example, specified in the operational description below and the flowchart of FIG. 3C. Processor 750 relays information via, for example, wireless communication link 760 (which may, for example, be an RF connection using, for example, Zigbee protocol) to local data communication device 150. A wireless RF communication connection may, for example, be established via a Microchip MRF24J40MA-I/RM Zigbee module available from Microchip Technology, Inc., which is controlled by processor 750.

FIG. 3B illustrates schematically an embodiment of a circuit diagram of sensor system 700. As illustrated in FIG. 3B a power source 704, including, for example, one or more batteries, is in electrical connection with power management circuitry 706 to provide power to temperature sensor(s) 710, ambient temperature sensor 720, a real time clock 724, processor 750, and wireless communication device 760. In the illustrated embodiment, processor 750 is in communicative connection with EEPROM memory 752.

FIG. 3C illustrates a flow chart of an embodiment of a mode of operation of sensor system 700. As set forth in FIG. 3C, the surface temperature of an area of cooktop 800 is measured, integrated and stored. The ambient temperature is also measured and stored. The temperature difference (ΔT) between the integrated cooktop surface temperature and the ambient temperature is calculated and recorded. In a number of embodiments, when an increase of ΔT is noted which is above a rolling average, the time is noted and system 700 begins calculating a rate of rise. System 700 logs the rate of rise of temperature and the absolute temperature. Once the rate or temperature rise decreases below a predetermined threshold, an ultimate temperature is determined. Using rate or rise in temperature, ultimate temperature, etc. and predetermined or adaptive readings, system 700 logs an event such as stove or oven on or both on. A change in state or event (for example, an “on”/“off” state change such as “stove on”, “oven on” or “stove and oven on”) is transmitted to local data communication device 150. From the rate of fall, final temperature calculations, and prior status, a determination and logging of an event such as stove off, oven off or both stove and oven off is made. After such a determination, corresponding information is transmitted to local data communication device 150.

When a decrease in ΔT is noted below the rolling average, the time is noted and a rate of fall calculation is initiated. The rate of temperature decrease is compared to a predetermined status (for example, stove on, oven on or both stove and oven on).

As described above, determination as to whether to transmit or upload on exception may made by one or more of the processing system(s) of the local system based upon preprogrammed rules or protocols. If, for example, a “stove on” and/or “oven on” time exceeds a predetermined duration, an upload on exception to local data communication device 150 may be initiated. Likewise, if a measured temperature exceeds a predetermined temperature, an upload on exception to local data communication device 150 may be initiated.

FIG. 3D(i) illustrates a representative embodiment of a sensor system configuration used in a number of studies of a sensor system of FIG. 3A. In the illustrated embodiment, an array of CEN-TECH®, non-contact, pocket thermometers as temperature sensors 710 (1:1 spot size) available from, for example, Harbor Freight Tools of Calabasas, Calif. USA. Temperature sensors 710 were positioned approximately 6 inches above the countertop surface next to a stove including four burners above an oven. FIG. 3D(ii) illustrates the result of studies wherein the oven is turned on to approximately 350° F. and left on for approximately 22 minutes, while the range burners are left off. Before the oven is turned on, the stovetop surface and burners were all at room temperature or ambient (approximately 65° F.). After approximately 22 minutes of having the oven on at 350° F., the temperature of the stovetop increased to 72.8° F., while the temperature of the burners increased only slightly. FIG. 3D(iii) illustrates the results of a continuation of the studies of FIG. 3D(ii) wherein the oven is turned off and stove top temperature is monitored over time. The interior of the stove heats relatively quickly (from ambient temperature to 350° F. in approximately 20 minutes. The surface of the stove takes longer to reach its final or equilibrium temperature as a result of, for example, insulation. If the oven is turned off before the stovetop surface reaches equilibrium, the heat will equalize through the exterior, raising the temperature of the surface and then gradually decreasing back to ambient temperature. FIG. 3D(iv) illustrates the results of a continuation of the studies of FIG. 3D(iii), In FIG. 3D(iii), the oven has been turned off for 45 minutes. However, the temperature of the stovetop surface is still above ambient temperature 45 minutes after the oven is turned off.

FIG. 3D(v) illustrates the result of studies wherein the left rear burner is turned on to its lowest setting (right side of the figure) and its highest setting (left side of the figure), while the oven is off. The right side of FIG. 3D(v) sets forth temperatures over time for left rear temperature sensor 710, the burner, and right rear temperature sensor 710 after the left rear burner is turned off from its highest setting.

FIG. 3D(vi) illustrates the results of studies wherein the right burner is turned on to its lowest setting, while the oven is off. In the left side of the figure, temperatures are set forth for left front temperature sensor 710, the burner, and right front temperature sensor 710 when the right front burner is off and two minutes after the right front burner has been turned on. The right side of FIG. 3D(vi) illustrates temperatures for left front temperature sensor 710, the burner, and right front temperature sensor 710 five minutes after the right front burner has been turned on. In the studies of FIG. 3D(vi), the stovetop surface was still warm (that is, above ambient temperature) from an earlier “oven on” study, but temperature sensors 710 could readily detect temperature differences resulting from the on/off state of a burner. FIGS. 3D(i) through 3D(vi) illustrate that measuring/analyzing temperature over one or more areas of, for example, a stovetop surface over time enables one to relate temperature changes over time to changes in state of the system. On/off states of burners and the stove are readily determined and distinguished.

Sensor system 700 provides a universal sensing system for use in connection with devices, systems and appliances which generate heat. Sensor system 700 may, for example, be used in connection with one or more other sensor system hereof in monitoring a device, system and/or appliances. For example, sensor system 700 may be used in connection with energy, sensor system 400 in connection with, for example, electric stoves.

In another embodiment of a sensor system hereof to sense, for example, kitchen related activity (or inactivity), change over time of a variable related to an “absolute” measure of the surrounding air's moisture content is analyzed. The environmental conditions of, for example, a kitchen change with certain activities such as cooking and washing. All of the various methods of cooking, including, but not limited to: cooking with gas, electric, microwave or induction appliances; and washing, by hand or machine, for example, change environmental conditions, including the moisture content of the surrounding air. The temperature and/or quantity of moisture in the air in the kitchen change with the introduction of heat and/or additional moisture as a byproduct of the cooking and/or washing process. A plurality of systems/activities can be monitored at the same time by monitoring moisture content in air.

In a number of embodiments of systems hereof, the change in dew point is determined and analyzed as a function of time. Dew point is the temperature at which water vapor in a volume of humid air (at constant barometric) pressure will condense into liquid water. Dew point is thus a water-to-air saturation temperature and is associated with relative humidity. Increasing relative humidity indicates that the dew point is becoming nearer to the current air temperature. At 100% relative humidity, the dew point is equal to the current air temperature and the air is saturated with water. Although dew point changes with external environmental factors, such as meteorological fronts passing through, a change (A) in dew point inside an enclosed space (for example, a kitchen of a residence) changes/equilibrates measurably more quickly than changes resulting from, for example, meteorological changes.

In a number of embodiments, one of sensor system 10a, 10b, 10c, 10d, 10e, 10f, 10g etc. is a sensor system (for example, for determining kitchen activities or lack of activities) including at least one temperature sensor and at least one humidity sensor. The sensing system measures the ambient environmental conditions, including temperature and humidity, and changes therein over time, to determine changes in state associated with certain activities within an area such as a kitchen. Dew point may be measured using a single sensor. In a number of embodiments, the sensor system measures both temperature and humidity over time and calculates dew point from these measurements. The sensor system further calculates changes in dew point, which may be indicative of certain activities, for the purpose of, for example, ascertaining the activity level and thus health and well-being of a resident, who as part of their normal routine, may be the sole user of a kitchen. In addition to activities which change the level of moisture in the surrounding air, certain “dry” (or non-moisture generating) activities or events, including, but not limited to, cleaning the oven with high heat, can generate temperature changes which may be detected by sensing system 900.

Dew point may, for example, be calculated from relative humidity and temperature as described below. A well-known approximation used to calculate the dew point T_{d} given the relative humidity RH in percent and the actual temperature T of air is:

$${T}_{d} = \frac{b γ ( T , RH )}{a - γ ( {T}_{s} RH )} \\ where \\ γ ( T , RH ) = \frac{a T}{b + T} + ln ( RH / 100 ) \qquad Algorithm 1$$

In a number of studies hereof, algorithm 1 used in determining dew point.

In the above equations, the temperatures are in degrees Celsius and “ln” refers to the natural logarithm. The constant a=17.271, and the constant b=237.7° C. The equation is based on the August-Roche-Magnus approximation for the saturation vapor pressure of water in air as a function of temperature and is considered valid for 0° C.<T<60° C.; 1%<RH<100% and 0° C.<T_{d}<50° C.

A very simple approximation that allows calculation of dew point from dry-bulb temperature (Celsius) and relative humidity is:

$${T}_{d} = T - \frac{100 - RH}{5} \qquad Algorithm 2$$

In algorithm 2, T is dry-bulb temperature in degrees Celsius and RH is relative humidity. The above relationship will be accurate within approximately +/−1° C. as long as relative humidity is greater than 50%.

A more accurate approximation of dew point is provided below.

$${e}_{s} = 6.112 exp ( \frac{17.67 T}{T + 243.5} ) \\ {e}_{w} = 6.112 exp ( \frac{17.67 {T}_{w}}{{T}_{w} + 243.5} ) \\ e = {e}_{w} - {p}_{sta} ( T - {T}_{w} ) 0.00066 [ 1 + ( 0.00115 {T}_{w} ) ] \\ RH = 100 \frac{e}{{e}_{s}} \\ {T}_{d} = \frac{243.5 ln ( e / 6.112 )}{17.67 - ln ( e / 6.112 )} \qquad Algorithm 3$$

In algorithm 3, RH is relative humidity in percentage and T_{d} is dew point in degrees Celsius. T and T_{w} are the dry-bulb and wet-bulb temperatures, respectively, in degrees Celsius. eₛ is the saturate water vapor pressure, in units millibar, at the dry-bulb temperature, e_{w} is the saturate water vapor pressure, in units millibar, at the wet-bulb temperature and e is the actual water vapor pressure, in units millibar. Pₛₜₐ is “station pressure” (absolute barometric pressure at the site for which humidity is being calculates) in units of millibar (which is also hPa).

As set forth above, rates of change of temperature, relative humidity and/or dew point can be used to differentiate local (nearby) cooking and/or washing activities, from normal atmospheric dew point variation. This differentiation is a function of the comparatively small volume of a kitchen, or other enclosed room or structure, versus atmospheric variation which has quantifiable maximum rates of change of dew point based on historical data and atmospheric diffusion models. Moreover, collecting data over a period of time enables the sensor system to adaptively learn the rates of change of dew point, temperature and humidity in its intended location to further enhance the ability to differentiate, for example, local cooking, washing or other kitchen activity events, from ambient atmospheric changes. Collecting data over a period of time also enables the sensor system to adaptively learn the rates of change of temperature in its intended location, to further enhance the ability to differentiate local cooking, washing or other kitchen activity events, from normal HVAC (heating, ventilation and air conditioning) operation.

Collecting data on temperature, humidity and dew point, and comparing the collected data against known practical limits for normal household conditions (for example, at a 99^{th} or other percentile) may be used to detect abnormal conditions within a location, for the purposes of recording, reporting or alerting users to an unusual or exceptional condition as, for example, described in connection with sensor system 700. Moreover, collecting data on temperature, humidity and dew point, to determine, for example, kitchen activity or unusual conditions, may be used in combination with information from other sensors, including, but not limited to, energy sensors, water sensors, bed sensors, etc., for the purpose of establishing an unusual or undesirable condition, such as a person being in bed while the stove is in operation, for the purpose of alerting or notifying relevant parties, including but not limited to caregivers, that an unusual or undesirable condition exists.

FIGS. 3E and 3F illustrates an embodiment of a sensor system 900 for determining and analyzing changes in dew point over time. In the illustrated embodiment, sensor system 900 includes ambient air temperature sensor 910, which may, for example, be shielded from direct radiated thermal energy released by kitchen appliances or other devices. Sensor system also includes a relative humidity sensor 920. The output signals from temperature sensor 910 and relative humidity sensor 920 may, for example, be used to calculate due point.

In the illustrated embodiment, sensors 910 and 920 are in communicative connection with, for example, amplification and/or signal conditioning circuitry 930 (which may, for example, include one or more voltage regulators 932 (see FIG. F), amplifiers and/or other signal conditioners). A power source 940 (for example, one or more batteries) is also provided. In the illustrated embodiment, sensor system 900 further includes a computer processor 950 (for example, a microprocessor such as a PIC24FJ128GA306-1 available from Microchip Technology, Inc. of Chandler, Ariz.), associated memory, and a wireless communication link or module 960 (as, for example, described in connection with energy sensor 400; for example, a MRF24J40MA Zigbee RF communication chip available from available from Microchip Technology, Inc.) to communicate with local data communication device 150. As illustrated in FIG. F, an EEPROM memory 970 and a real time clock 980 are also in communicative connection with processor 960. Sensor system 900 may also include one or more other sensors (represented generally as element 990 in FIG. 3F) such as an ambient light sensor (which can, for example, be used to determine time of day etc.). In a number of embodiment, a smoke detector/sensor is incorporated in sensor system 990.

FIG. 3G illustrates a flow chart of an embodiment of a mode of operation of sensor system 900. In the embodiment of FIG. 3G, temperature and relative humidity or RH are measured and the dew point is calculated once every 30 seconds. In a number of embodiments, kitchen activity was determined as follows. The average of the last five dew point calculations was determined (AVG(DPn-6 to DPn-1)). The last-five average number of dew point calculations was subtracted from the current dew point calculation. (DPn-AVG(DPn-6, DPn-1)). The value is referenced as DPslope in FIG. 3G. If the DPslope result is above 0.5, a start of a kitchen activity is marked. The number 0.5 may, for example, be different and/or optimized for different kitchens. A flag is set based on the absolute value of DPslope. If ABS(DPslope)<0.2, the flag is set to equal 0. Otherwise, the flag is set to equal 1. The value of 0.2 may, for example, be different and/or optimized for different kitchens. In the embodiment of FIG. 3G, the values of the flag for the last ten 30-second time steps are added to calculate a “stop of kitchen activity counter”. (Sum(flagDPn-11 to flagDPn-1.)) Kitchen activity is determined to have stopped if sum(flagDPn-11 to flagDPn-1) equals 10 (five minutes) and DPslope is less than 0.5. The values of 0.5 and 0.2 set forth above for DPslope and ABS(DPslope), respectively, provided acceptable results in a number of kitchens tested. However, varying such values may, for example, be changed via optimization and/or an adaptive algorithm.

FIG. 3H illustrated data taken over a period of several days using the methodology of FIG. 3G. The data illustrates the calculation of on/off (or start/stop) states for kitchen activities related to: (a) a dinner on day 1; (b) breakfast on day 2; (c) dinner on day 2; (d) breakfast on day 3; (e) dinner on day 3, (f) breakfast on day 4; and (g) dinner on day 4. Data points past 11000 data points corresponded to a weekend when no one was present in the home being studied.

As described above, various activities result in a change in dew point (for example, cooking via various kitchen utensils/utilities, washing, opening a refrigerator etc.). Various activities can be distinguished by analyzing the manner in which dew point changes and/or the manner in which temperature and/or relative humidity changes. The independent and/or directly detected variables of temperature and relative humidity and a variable dependent thereon or derived therefrom (for example, dew point) may thus be use individually or in any combination thereof to analyze changes in state or activities. For example, when a refrigerator door opens, temperature decreases slightly and relative humidity increases. In the case of certain stovetop cooking, temperature increases and relative humidity increases in a relatively steady manner. In the case of oven cooking, temperature increases in a relatively steady curve until the oven door is opens, when both temperature and relative humidity increase rapidly. In the case that a dishwasher is activated, relative humidity increases. Temperature also increases, but more slowly than relative humidity. In the case of a pot of water which boils until the water is gone, the temperature and relative humidity increase as the water boils. After the water is boiled away, the temperature increases by relative humidity decreases. Dew point remains relative constant throughout the process.

As also described above, determination as to whether to transmit or upload on exception may made by one or more of the processing system(s) of the local system based upon preprogrammed rules or protocols.

As, for example, illustrated in FIG. 3E, the sensor system 900 (or at least sensors 910 and 920) may be mounted on or near the ceiling (for example, within 1 inch of ceiling 1000), as normal convective flow from any cooking process will create a more readily detectable rise at or near ceiling 1000 than anywhere else in the kitchen. A configuration for sensor system 900 similar to a smoke detector is potentially advantageous as a result of a number of factors including low cost, ease of assembly and promotion of convective airflow across sensors 910 and 920. Sensor system 900 may, for example, be affixed with fasteners such as screws to ceiling 1000, or to a wall within the vicinity of ceiling 1000 (for example, with 1 inch thereof).

One or more sensor systems hereof can, for example, be used to measure one or more variables related to rest and/or sleep (for example, the duration of time that monitored person 5 is lying in bed, sitting in a chair, sitting on a sofa etc.), which are important parameters for monitoring the wellbeing of person 5. In addition to the duration of time spent in bed, the time of going to bed, the time of waking up and the time and duration of interruptions of sleep (such as associated with the use of the restroom in the middle of the night), may also be recorded. Failure to get out of bed by a certain time, for example, may be indicative of a problem requiring immediate attention (and defined as an exception event required an expedited or immediate upload of data to remote system 200).

Monitoring of bed usage can, for example, be accomplished in various manners including, for example, use of a pressure sensitive pad placed on or under the mattress of the bed to indicate the presence of a person in bed, or the use of a pressure sensor located on or under a leg of the bed and designed to monitor change in weight, thereby indicating the presence of a person in bed. Other sensor systems for sensing the presence of a person in a bed may, for example, include piezo resistive films, thick film strain sensors, infrared sensors, accelerometers, acoustic sensors, carbon dioxide sensors and/or body temperature sensors. Examples of bed sensors are, for example, described in U.S. patent application Ser. No. 13,631,971, filed Sep. 29, 2012 and PCT International Patent Application No. PCT/US2012/058162, the disclosures of which are incorporated herein by reference.

Sensor systems can also be used in connection with one or more medical devices (for example, diagnostic or treatment devices) used in connection with the monitored person's body or medical care. For example, dental CPAP appliances are sometimes used to treat persons suffering from obstructive sleep apnea. Compliance with dental CPAP device therapy is, on average, less than 60% in the United States. One or more sensors can, for example, be used to monitor persons using dental CPAP appliances, and track the hours of usage of such devices. A sensor system can, for example, be placed on the side of the dental CPAP device, which, when in use, resides in the person's mouth and senses the use of the dental CPAP device by, for example, sensing changes in temperature or conductivity in the person's mouth. The data can then be transmitted to remoter system 200 for compliance tracking purposes.

In another embodiment, one or more sensor systems can, for example, be placed in operative connection with a continuous positive airway pressure or CPAP device (or other positive airway pressure of PAP device) often used by persons suffering from obstructive sleep apnea to monitor, for example, compliance. For example, a CPAP sensor can transmit data of the on time, the off time, the usage time, and the average pressure rather than transmitting a stream of analog data, which is then interpreted on the server side.

Persons undergoing treatment for chronic or other health conditions in the home such as obstructive sleep apnea (OSA) and other conditions require frequent monitoring. A comprehensive monitoring program involves the collection of both quantitative and qualitative metrics. While quantitative metrics are most easily collected using sensors and associated devices, qualitative methods generally require an interaction with the person using a variety of systems and/or methods, including conversations over the phone, internet, SMS methods, or via mail.

Using conventional manual methods, a nurse or healthcare provider typically reviews the output of quantitative metrics from sensors and modifies a conversation with person 5 accordingly to collect the most appropriate qualitative data possible. When utilizing automated or semi-automated methods, however, such as IVR, web-based surveys, or similar methods, it is difficult to dynamically change the qualitative data collection based upon sensors, thereby reducing the effectiveness of the qualitative monitor and increasing the number of questions and/or surveys required of person 5 (which contributes to dissatisfaction).

In a number of embodiments hereof, a medical device monitoring device or system (for example, a PAP monitoring device) collects usage, compliance, and clinical efficacy data. The device can be used in conjunction with a management tool incorporated within or operating in conjunction with monitoring system 50 that is, for example, at least partially automated to contact person 5 (utilizing, for example, IVR, SMS, email, and/or internet communication methods) whereby the questions asked and the data collected via the management tool are changed based upon the data being collected from the PAP monitoring device.

For example, current OSA patient management technology asks a patient or person how long and how frequent they have been using their therapy. With the incorporation of the PAP monitoring device, rather than asking how long they've been using their therapy, the management tool can tell them how long they've been using it and offer feedback (positive or negative) to the person. Such a methodology provides a more effective monitoring with higher satisfaction.

As discussed above, transmitting state-based or value-based data (for example, periodically) reduces cost, lowers bandwidth usage, and requires less memory as compared to continuous, real-time transmission of analog data. The transmission of state-based data hereof to remote system 200 may be in a batch manner as described above or may be continuous or substantially continuous in, for example, the case of an available broadband connection between local system 100 and remote system 200. As further described above, in the case of some type of devices such as medical or physiological devices which monitor movement or physiological parameters (for example, temperature, heart rate etc.) it may be desirable to transfer data at very short periods or even continuously. For such monitoring systems it may be desirable to include a communication module in the associated sensor system for continuous transmittal of data to, for example, local data communication device 150 and ultimately to remote system 200. Table 1 provides a summary of several devices describing the functions or activities monitored, the data type to be transmitted to the remote system 200 and whether the transmission of such data may, for example, be periodic or continuous in a number of embodiments hereof.

TABLE 2

| Item being | Description of what | | Periodic and/or continuous |
|---|---|---|---|
| monitored | monitored | Data type | monitoring/uploading |
| Sleeping patterns | Monitor when the person | Hours, Times of changes | Periodic (but may require timed update |
| | is and is not in bed | of status | that is programmable or an hourly |
| | | | update) |
| Television | Monitor when the | Hours, Times of changes | Periodic (daily update may be |
| | television is on and off | of status | sufficient) |
| Refrigerator | Monitor the times that the | Times of changes in | Periodic (daily update may be |
| | refrigerator is opened. | status | sufficient) |
| Oven | Monitor the times that the | Times of changes in | Periodic (daily update may be |
| | oven is on. | status | sufficient) |
| Microwave | Monitor the times that the | Times of changes in | Periodic (daily update may be |
| | microwave oven is on. | status | sufficient) |
| Lights / lamp | Monitor the times that the | Hours, Times of changes | Periodic (daily update may be |
| | light is on. | of status | sufficient) |
| Water | Measure water flow at the | Hours, Times of changes | Periodic (daily update may be |
| consumption | water intake pipe of the | of status | sufficient) |
| | house or at any desired | | |
| | water-using device. | | |
| Patient physiology | Temperature, heart rate, | Depends upon | May be periodic with increased |
| | blood pressure etc. | physiological parameter | frequency of upload or may be |
| | | being monitored | continuous |

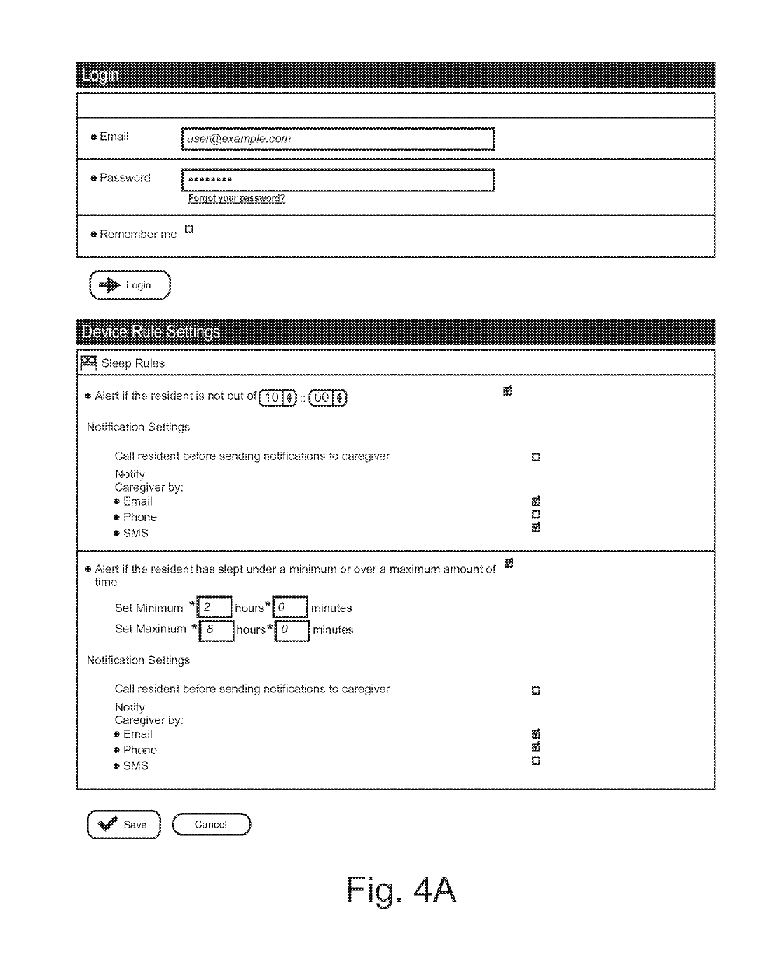

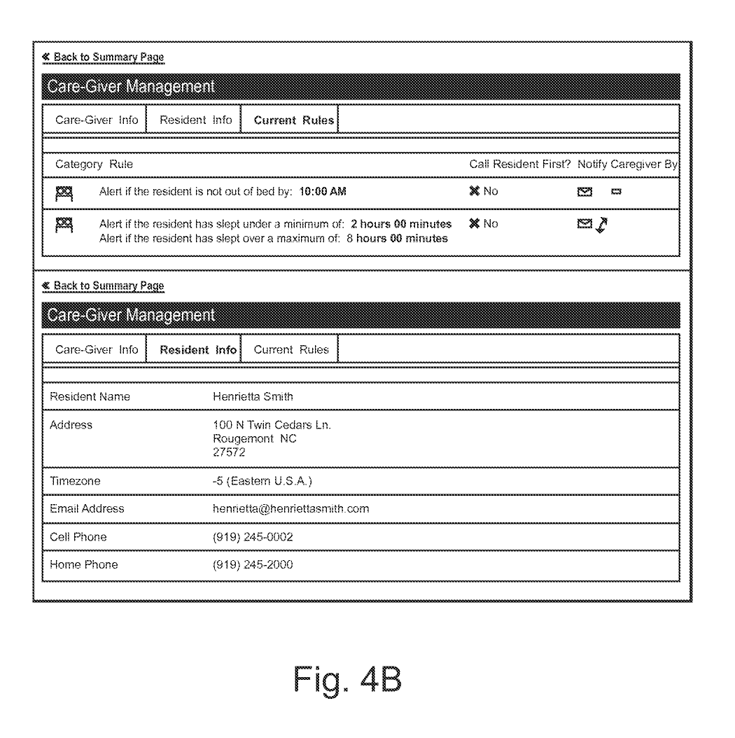

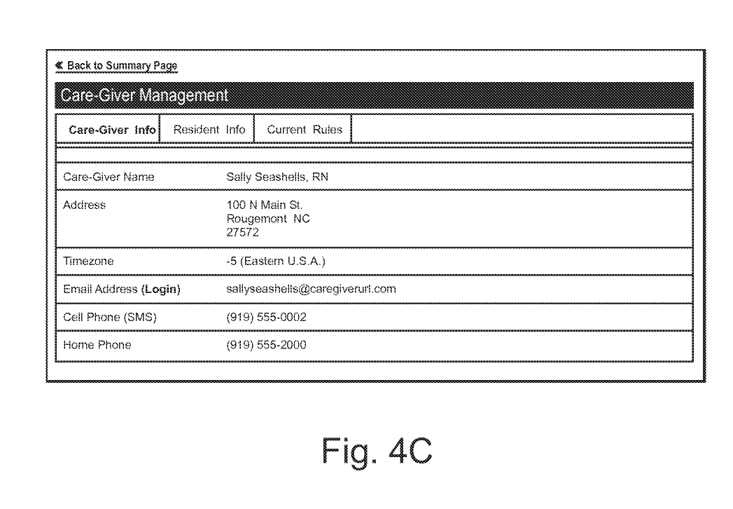

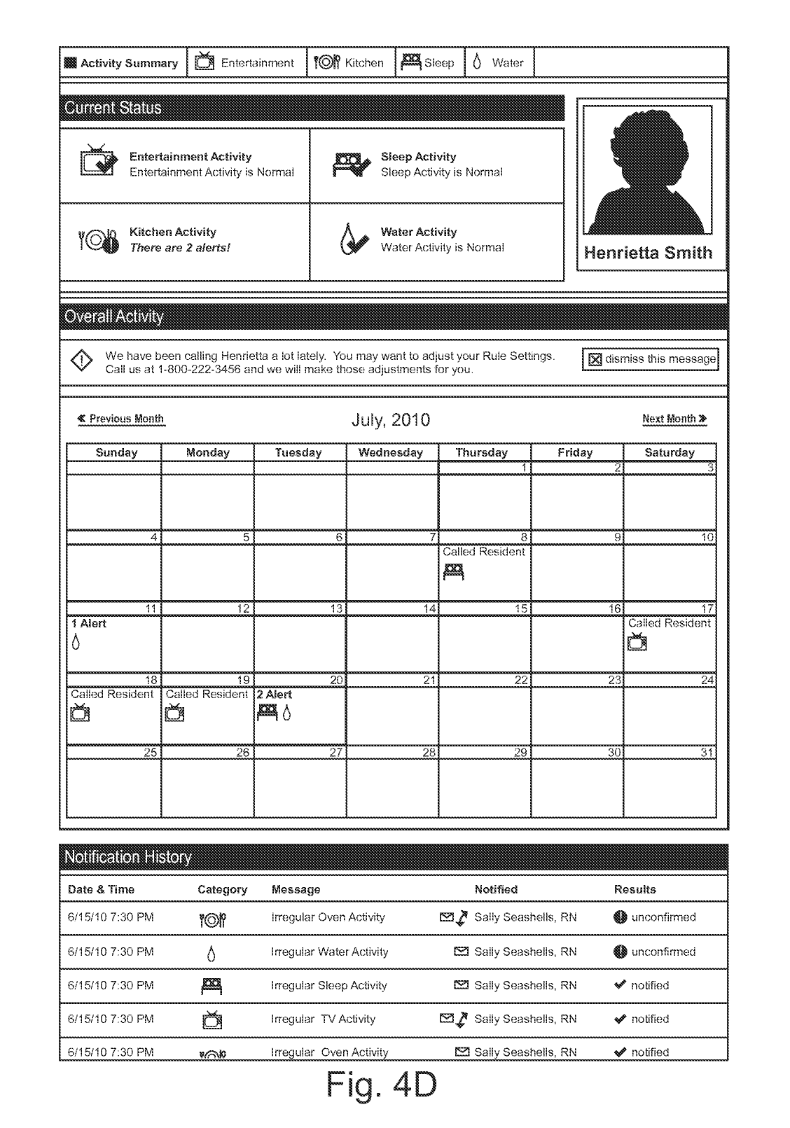

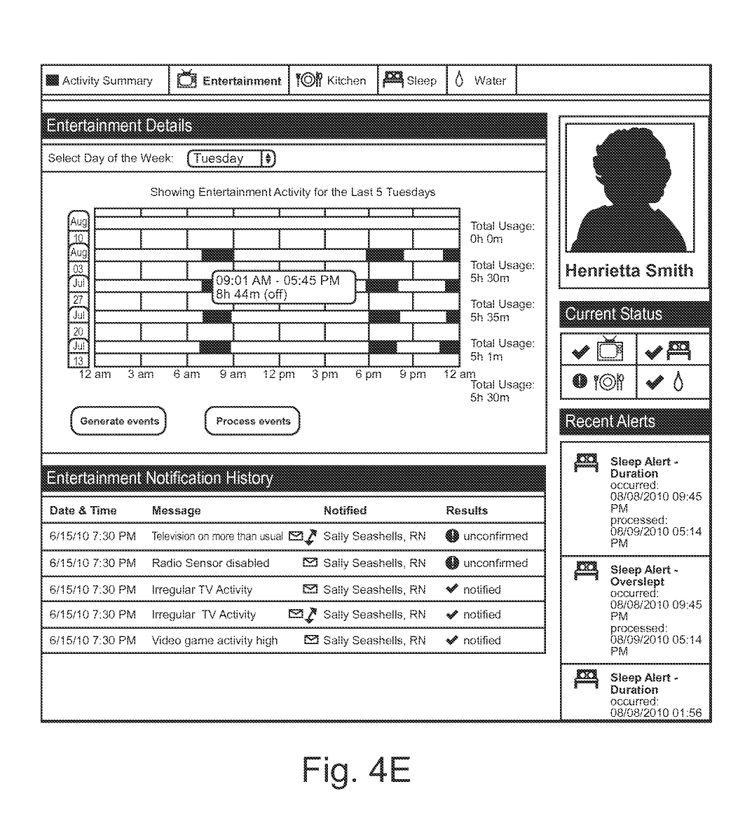

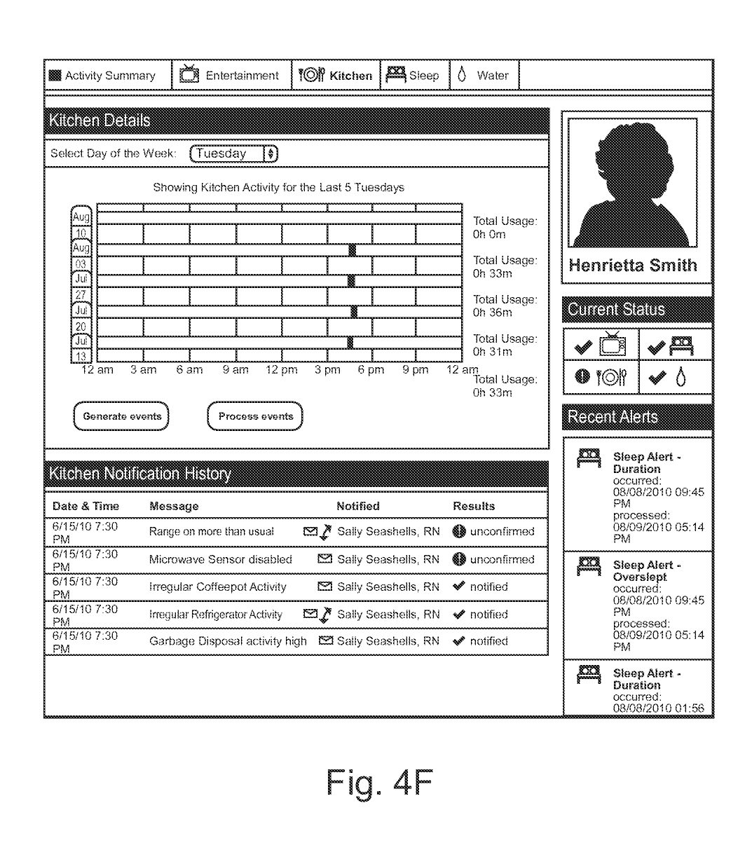

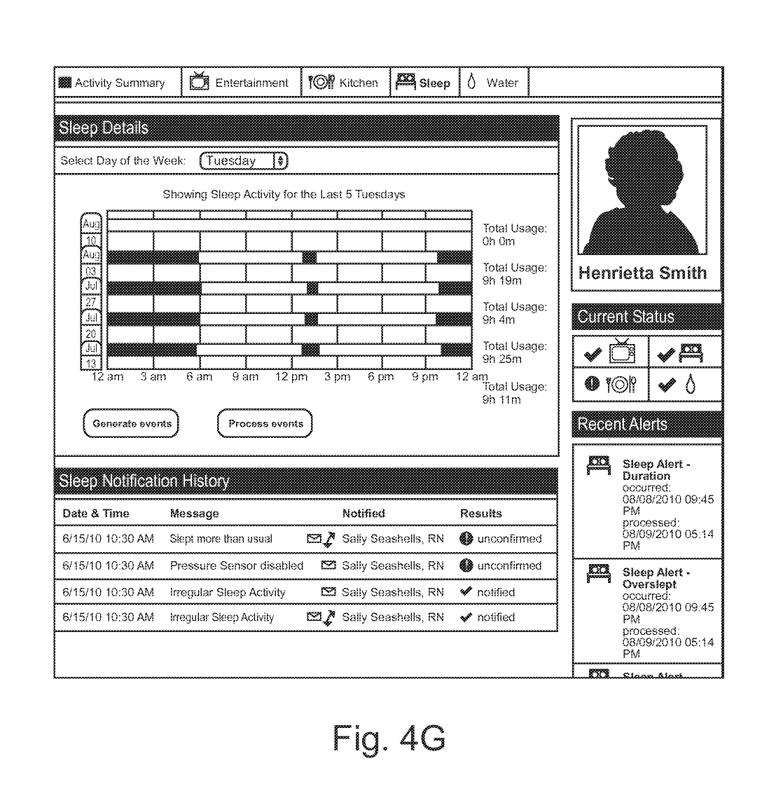

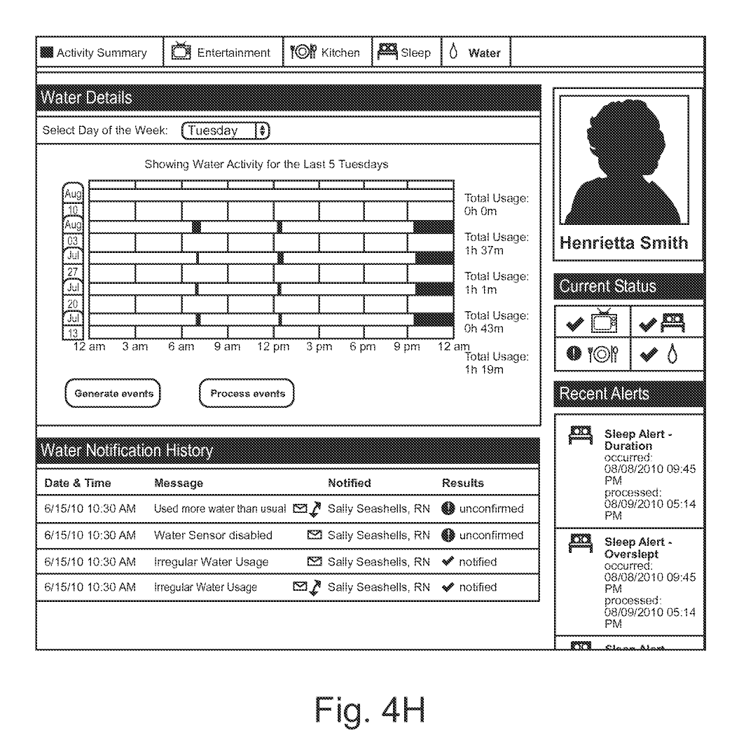

FIGS. 4A through 4H illustrate representative embodiments of computer screen captures from sever-based programming of remote system 200 which are representative of the setup and function of a number of aspects of the systems and methods hereof. In that regard, one or more users or system operators are provided with display/interfaces (for example, web pages via a graphical user interface) to enable setup, configuration, review etc. of monitoring system 50 and the components thereof (see, for example, FIG. 1B).

FIG. 4A illustrates an embodiment of a screen for login and for monitored device rule settings. In that regard, FIG. 4A sets forth a number of rules for the monitored persons sleep activity and associated alerts. FIG. 4B illustrates an embodiment of a screen summarizing rules for alerts to caregivers related to bed activity and an embodiment of a screen summarizing resident information.

FIG. 4C illustrates an embodiment of a screen summarizing caregiver information. FIG. 4D illustrates an embodiment of a screen setting forth an activity summary screen derived from state-based sensor data. Server system 210 can, for example, include logic or learning algorithms to notify an operator of possible modifications (for example, rule changes) that might be desirable to improve operation based upon past actions or experiences (for example, excessive alerts, false alerts etc.) Different categories of activities can, for example, be categorized for ease of viewing and/or analysis. As illustrated in FIG. 4D, a type or category of activity can be selected for viewing and/or analysis from a menu. FIG. 4E illustrates an embodiment of a screen setting forth entertainment activity derived from state-based sensor data from a television, a radio and a computer (video game activity). As illustrated in FIG. 4E, the time of uses and duration of uses can be set forth for a defined period of time. FIG. 4F illustrates an embodiment of a screen setting forth activity derived from state-based kitchen device sensor data from sensor systems associated with a range, microwave, coffeepot, refrigerator and garbage disposal. FIG. 4G illustrates an embodiment of a screen setting forth sleep activity derived from state-based sensor data from one or more sensor systems associated with a bed. FIG. 4H illustrates an embodiment of a screen setting forth water use derived from state-based sensor data from a sensor associated with a water utility inlet into space 10.

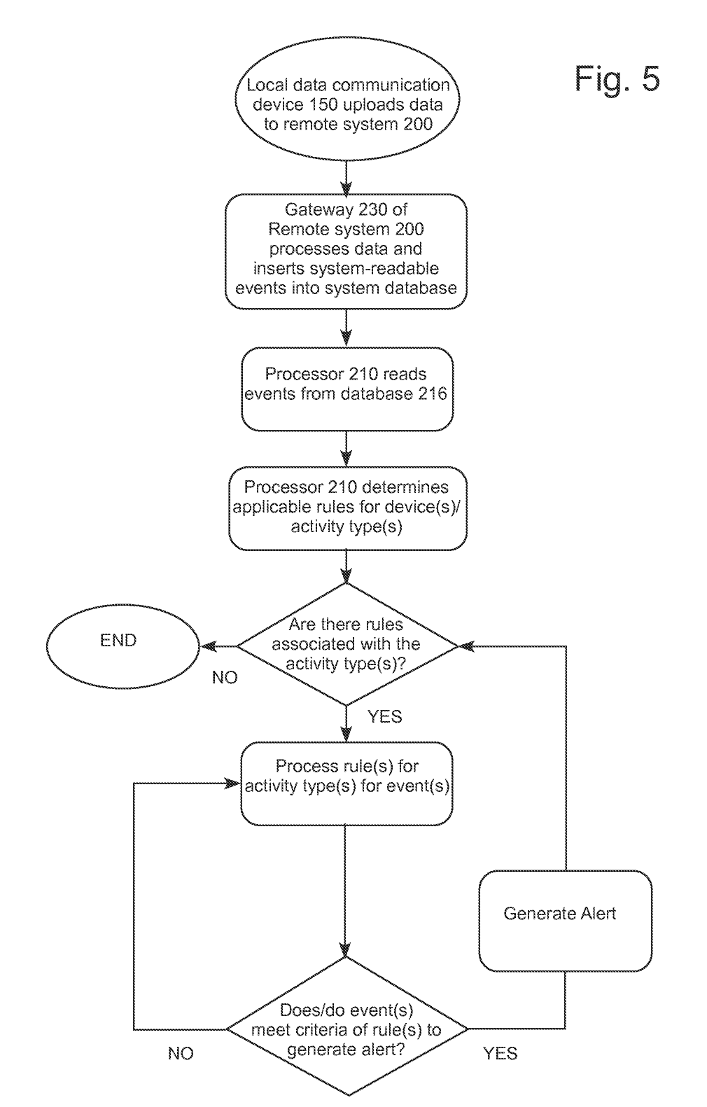

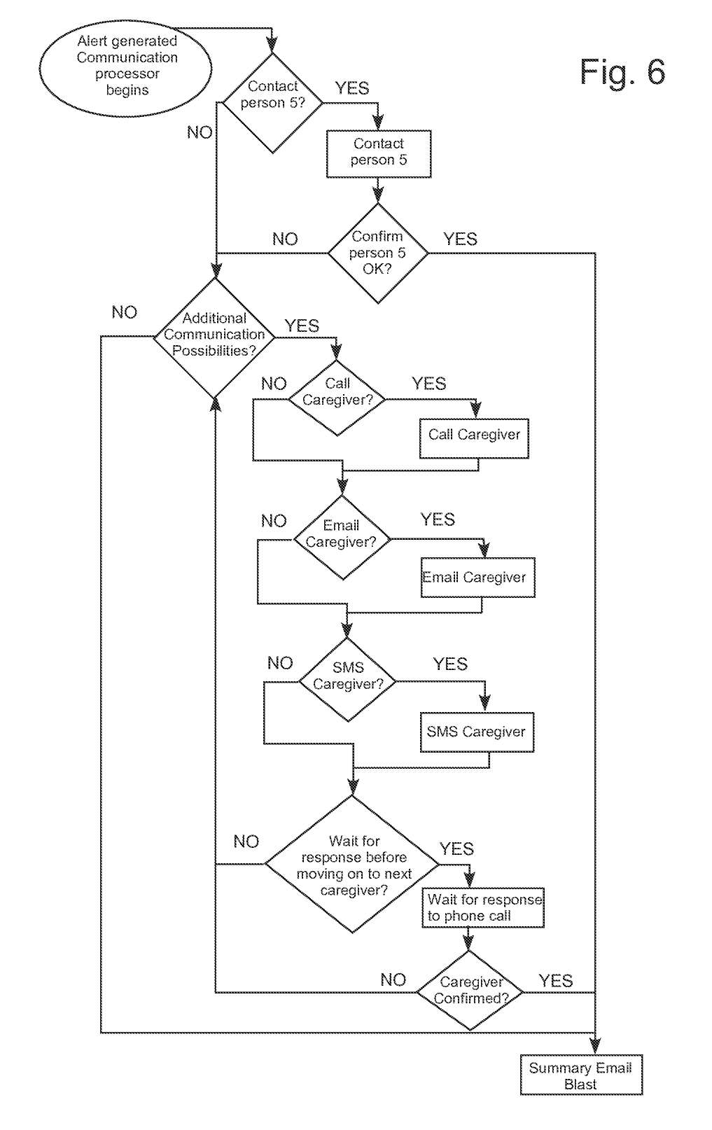

FIG. 5 illustrates a flowchart for an embodiment of methodology for the uploading of data to remote system 200, the determination of associated or relevant rules and the application of such rule to determine whether an alert should be generated. FIG. 6 illustrates a flowchart for an embodiment of methodology for alerting one or more caregivers via one or more communication devices or systems and including an optional attempt to confirm person 5 is OK via an attempt to communicate with or contact person 5.

When monitoring the wellness of person 5, it is necessary to track their behavior on a day to day basis. Such behavior, however, can change at different times of day and from day to day, based upon, for example, whether it is a weekend or a weekday, a holiday or a workday etc. If a wellness monitoring system is designed to generate alerts based upon personal behavior using the same alert thresholds or triggering events at all times/dates, the probability is significant that alerts will be falsely issued or missed on “special” days such as days away from home, weekends, vacations or holidays.

In a number of embodiments, one or more sensitivity settings can be adjusted for specific classifications of time of day and/or dates/days (for example, weekends, holidays, vacations or even seasons of the year). For example, a sensitivity setting can involve a high, medium, or low setting, and corresponding thresholds which change based upon the sensitivity setting and corresponding alerts. Such sensitivity settings result in more accurate alerts (for example, less false positives/negatives.). Moreover the timing of uploads of data from local system 100 to remote system 200 may be altered depending upon time of day and/or dates/days. For example, a frequency of upload may be changed (for example, from three times per day to once per day).

Regardless of system settings, and depending upon personal behavior and monitoring characteristics, there is always the possibility of false alerts being generated. Such false alerts can result in false alarms, lost productivity, and unnecessary expense.

In a number of embodiments of the systems and methods hereof, monitored person 5 can, for example, receive an automatic verification phone call and/or other communication prior to the generation of an alert to one or more remote caregivers. Such a phone call can, for example, attempt to verify that person 5 is in need of assistance to reduce false positives or false alarms.

As described above in connection with uploads upon exception, monitoring various parameters, devices or appliances individually does not take into account information that can be derived by looking at multiple devices at the same time and correlating data therefrom. For example, in the case of a person who has been in bed for a predetermined extended period while the kitchen range is on, in the case that lights are illuminated during off hours for an extended period of time, or in the case that heating/air conditioning settings and/or usage does not correlate with the outside temperature, the person might require assistance. Monitoring of one of these parameters alone or collectively with no correlation of the resultant data may not result in identification of the person's needs. In a number of embodiments, data from sensor systems monitoring devices/systems that are not related or would not be normally grouped together with regard to a particular activity are analyzed to identify anomalies or abnormalities indicative of a condition requiring an action such as an alert or an upload upon exception.

In a number of embodiments of the systems and methods hereof, an array or network of sensor systems operate in concert with each other and data therefrom is correlated such that the wellbeing of the monitored person can be tracked and exceptions and/or alerts can be generated based upon events or values from multiple sensor systems or parameters, tracked in parallel. The data for a plurality (including at least two) sensor systems is thus monitored and correlated using predetermined rules and/or logic to determine if the combination of data from the plurality of sensors indicate the need for an alert. More accurate alerts are thus possible over the case of non-correlated data from individual sensors.

Sensor systems and/or local data communication devices 10 designed to monitor behavior which use a dial up modem, an internet modem or another communication device to transmit data can, for example, be tracked and linked to a specific person based upon a pre-assigned identification code. While such a code identifies the modem or communication device, it does not prevent the device from mistakenly being moved from one location to another. Data transmitted via such a modem or other communication device could be assigned errantly to one person when it actually belongs to another. Because healthcare providers, in the normal course of business, typically move monitoring devices from one person to another, the possibility of errors and errant data transmissions exists.

In a number of embodiments, in addition to the use of a unique identifier associated with a modem or other communication device, the systems and methods hereof incorporate the collection of phone number, IP address etc. from which a modem or other communication device is transmitting data. This information can, for example, be collected in software associated with the device and is linked to an existing person within a database. In the event that a matching phone number, IP address and/or other indication of origin cannot be identified and paired with an existing COM device serial number, the data can, for example, be stored in a staging status until a time when phone number, IP address (for example, a static IP address) etc. can be linked to an existing person. Such identifying data can, for example, reduce errors and reduce or eliminate the potential for errors in data transmission between healthcare providers or caregivers

In addition to wellness monitoring, information from sensor system systems hereof may, for example, also be used for security monitoring of for monitoring for unauthorized use. In that regard, activities sensed by the sensor systems hereof may be associated with an unauthorized access to space 5 or a portion thereof. For example, if space 5 is to be unoccupied for a period of time (for example, during a particular season in the example of the occupant(s) travelling south for winter months), detected activities or a particular type of may be associated with the presence of an intruder. Sensor systems hereof may, for example, be integrated with or placed in communication with many types of security systems in new installations and via retrofitting or addition to existing systems

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A method of monitoring a space to determine at least one change in state related to at least one activity, comprising: analyzing an amount of water vapor in the air over time and relating a change in the amount of water vapor in the air over time to the at least one change in state.

2. The method of claim 1 wherein the at least one change in state is related to a kitchen activity which causes a change in the amount of water vapor in the air.

3. The method of claim 1 wherein changes in dew point over time are determined.

4. The method of claim 3 wherein changes in dew point over time are determined by measuring temperature and relative humidity over time and determining dew point from measured temperature and measured relative humidity.

5. The method of claim 4 wherein changes in dew point over time are used to identify the activity associated with the change in state.

6. The method of claim 4 wherein at least one of change in dew point, change in relative humidity and change in temperature over time is used to identify the activity associated with the change in state.

7. The method of claim 1 further comprising associating the at least one change in state with wellness of a person.

8. The method of claim 1 further comprising associating the at least one change in state with unauthorized presence within a space.

9. The method of claim 1 further comprising associating the at least one change in state with a security breach.

10. The method of claim 1 wherein a beginning of the at least one change in state is determined and an end in the at least one change in state is determined.

11. A system to sense at least one change in state related to at least one activity, comprising: at least one sensor system to sense an amount of water vapor in the air, a processor system in communicative connection with the sensor system, and a communication system in communicative connection with the processor system.

12. A system for monitoring wellness of a person, comprising:
a local system in the vicinity of the person comprising:
a plurality of sensor systems, each of the plurality of sensor systems being adapted to monitor changes in state caused by activity or lack of activity of the person, at least one of the plurality of sensor systems being a sensor system to sense an amount of water vapor in the air, the sensors system to sense an amount of water vapor in the air comprising a processor system in communicative connection therewith, and a communication system in communicative connection with the processor system; and
a local data communication device in communicative connection with each of the plurality of sensor system to receive data from each of the plurality of sensor systems.

13. A method of monitoring a system to determine at least one change in state of the system, comprising: analyzing temperature over at least one area of the system over time and relating a change in the temperature over the at least one area of the system over time to the at least one change in state.

14. The method of claim 13 wherein temperature of the at least one area is integrated.

15. The method of claim 14 wherein integrating comprises averaging.

16. The method of claim 14 wherein the integrated temperature is determined by at least one temperature sensor having a field of view corresponding to at least a portion of the at least one area.

17. The method of claim 16 wherein the temperature sensor is an IR sensor spaced from the system.

18. The method of claim 14 wherein the at least one change in state is related to a kitchen activity effected using the system.

19. The method of claim 14 wherein at least a rate of change of the integrated temperature and an ultimate temperature change are used in determining the at least one change in state.

20. The method of claim 13 comprising analyzing temperature over a plurality of areas of the system over time and relating changes in the temperature over the plurality of areas of the system over time to the at least one change in state.

21. The method of claim 13 further comprising associating the at least one change in state with wellness of a person.

22. The method of claim 13 further comprising associating the at least one change in state with unauthorized presence within a space.

23. The method of claim 13 further comprising associating the at least one change in state with a security breach.

24. The method of claim 13 wherein a beginning of the at least one change in state is determined and an end in the at least one change in state is determined.

25. A system to sense at least one change in state related to an activity, comprising: at least one sensor system to measure temperature over at least one area of a monitored system, a processor system in communicative connection with the sensor system, and a communication system in communicative connection with the processor system.

26. The system of claim 25 wherein temperature of the at least one area is integrated.

27. The system of claim 26 wherein integrating comprises averaging.

28. The system of claim 26 wherein the integrated temperature is determined by at least one temperature sensor having a field of view corresponding to at least a portion of the at least one area.
